(19) United States
(12) Patent Application Publication
(10) Pub. No.: US 2010/0149655 A1
(43) Pub. Date: Jun. 17, 2010

(54) PROJECTION-USE ZOOM LENS

(75) Inventors: Takeshi Kitakata, Aichi (JP); Takahiro Sugiyama, Saitama-ken (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi, Aichi (JP)

(21) Appl. No.: 12/088,201

(22) PCT Filed: Sep. 26, 2006
(86) PCT No.: PCT/JP2006/319081

§ 371 Date: Mar. 26, 2008

(30) Foreign Application Priority Data
Sep. 26, 2005 (JP) 2005-277952
Sep. 26, 2005 (JP) 2005-277953
Mar. 24, 2006 (JP) 2006-082099

(51) Int. Cl. G02B 15/14

(52) U.S. Cl. 359/686; 359/689

(57) ABSTRACT

The present invention provides a zoom lens having fewer constituting lenses and capable of easily keeping telecentricity. From a projection plane side, lens groups ranging from a first lens group to a fourth lens group are disposed, sequentially. The first lens group consists of the three lenses, one negative lens, one positive lens and one negative lens arranged sequentially from the projection plane side, and has a negative power. The second lens group consists of three lenses in total, that is, one positive lens, one compound lens and one compound lens arranged sequentially from the projection plane PL side and has a positive power. The third lens group consists of one negative lens. The fourth lens group consists of one positive lens. At power varying, the first lens group and the second lens group are moved with the third lens group and the fourth lens group kept fixed. The third lens group is moved for focusing.

### CROSS-REFERENCE TO RELATED APPLICATIONS

The present application is a Continuation-in-Part of International Application No. PCT/JP2006/319081 filed Sep. 26, 2006, which claims the benefits of Japanese Patent Application No. 2005-277953 filed September 26, Japanese Patent Application No. 2005-277952 filed Sep. 26, 2005, and Japanese Patent Application No. 2006-082099 filed Mar. 24, 2006.

### BACKGROUND OF THE INVENTION

1. Field of the Invention

The present invention relates to a zoom lens used in a projection optical system.

2. Description of the Related Arts

Conventionally, as a projection-use zoom lens, optical systems of various types have been proposed. For example, the optical systems described in patent document 1 (JP-A-2004-77950), patent document 2 (JP-A-2004-54021), patent document 3 (JP-A-2003-215453), patent document 4 (JP-A-2003-215455) and patent document 5 (JP-A-2000-292698) have been proposed.

However, with respect to the optical systems described in these patent documents 1 to 5, the number of constituting lenses is nine or more thus giving rise to a drawback that a lens system becomes large-sized in addition to the increase of a lens cost. Here, in this specification, a compound lens equivalent to a single lens in terms of power is counted as one lens as a whole. “A compound lens equivalent to a single lens in terms of power” implies a compound lens consisting of lenses with cemented leens surfaces having the same radius of curvature (R). In general, with respect to the lenses which constitute such a compound lens, refractive indexes are made different from each other between the neighboring lenses so as to realize achromatization. However, in this specification, even when the refractive indexes of the neighboring lenses have the same refractive index, provided that the cemented lens surfaces of the neighboring lenses have the same radius of curvature (R), such a compound lens is considered as “a compound lens equivalent to a single lens in terms of power”.

Further, in view of the light emitting characteristic of an image element (that is, in view of a fact that when light incident on liquid crystal or an optical element part such as prism has an angle, the light possesses the polarization property and hence, chromaticity is changed or reflectance is deteriorated), it is preferable to design the projection-use zoom lens by imparting telecentricity (particularly, telecentricity on an image side) to the projection-use zoom lens. On the other hand, in the projection-use zoom lens, focusing is performed using a lens close to the image element in general. Accordingly, in the conventional focusing lens, it is also necessary to take the telecentricity into consideration. For example, recently, for the purpose of projecting a larger quantity of light of the image element as well as for miniaturizing a lens system, a condensing lens is arranged directly in front of an image element in general. In this case, however, when a focusing lens arranged close to the image element is constituted of one positive lens, there arises a drawback that the telecentricity is deteriorated.

### SUMMARY OF THE INVENTION

The present invention has been made in view of the above-mentioned circumstances. It is an object of the present invention to provide a projection-use zoom lens having the fewer constituting lenses than a conventional projection-use zoom lens. It is another object of the present invention to provide a projection-use zoom lens which can easily keep telecentricity.

To achieve the above-mentioned objects, according to a first aspect of the present invention, there is provided a zoom lens including a first lens group, a second lens group, a third lens group and a fourth lens group arranged sequentially from a projection plane side and capable of varying power between a short focal end and a long focal end thereof. The first lens group is constituted of three lenses consisting of one negative lens, one positive lens and one negative lens arranged sequentially from the projection plane side and has a negative power. The second lens group is constituted of three lenses in total consisting of one compound lens or one positive lens, one positive lens or one compound lens, and one compound lens arranged sequentially from the projection plane side and has a positive power. The third lens group is constituted of one negative lens. The fourth lens group is constituted of one positive lens. In varying power, the zoom lens is configured such that the first lens group and the second lens group are moved, while the third lens group and the fourth lens group are fixed and, further, the zoom lens is configured to move the third lens group for focusing.

In this zoom lens, a focal length can be varied by moving the first lens group and the second lens group. Further, in this zoom lens, focusing can be performed by moving the third lens group.

Further, the fourth lens group constitutes a condensing lens for projecting a larger quantity of light of an image element and, at the same time, for reducing an outer diameter of a lens system. According to the present invention, the zoom lens is configured to keep telecentricity due to an optical system ranging from the first lens group to the fourth lens group. Here, keeping of telecentricity implies a state where a main light beam and an optical axis are arranged substantially parallel to each other (including inclination of approximately ±10°)

The zoom lens of the present invention may be configured to satisfy a following conditional expression (1).

0.7≦|f₂/f₁|≦1.5 (1)

f₁: combined focal length of the first lens group

f₂: combined focal length of the second lens group

The zoom lens of the present invention may be configured to satisfy a following conditional expression (2).

1.5≦|f_{b}/f_{w}|≦2.5 (2)

f_{b}: combined back focusing ranging from the first lens group to the third lens group

f_{w}: focal length at the short focal end

The zoom lens of the present invention may be configured to satisfy a following conditional expression (3).

0.08≦|f_{T}/f₃|≦0.3 (3)

f₃: combined focal length of the third lens group

f_{T}: focal length at the long focal end

A projector according to the present invention includes the above-mentioned zoom lens according to the present invention.

The above-mentioned conditional expressions (1) to (3) are explained hereinafter.

The conditional expression (1) is a condition for restricting the relationship between focal lengths of the first lens group and the second lens group which are moved for changing the focal lengths. When |f₂/f₂| assumes a value below a lower limit 0.7, the focal length of the first lens group becomes excessively large and hence, moving quantities of the first lens group and the second lens group for changing the focal lengths are increased thus eventually making the lens system large-sized. Accordingly, it is not favorable to set |f₂/f₁| to the value below the lower limit 0.7.

Further, when |f₂/f₁| assumes a value above an upper limit 1.5, such setting of |f₂/f₁| is advantageous for making the lens small-sized. However, the focal length of the first lens group becomes excessively small and hence, spherical aberration generated in the first lens group becomes excessively large. Accordingly, it is difficult to favorably correct the spherical aberration.

The conditional expression (2) is a condition for ensuring an air gap for inserting an illumination optical system between the third lens group and the fourth lens group for properly ensuring a light quantity of a projected image by setting a combined back focusing ranging from the first lens group to the third lens group to a predetermined size. When |f_{b}/f_{w}| assumes a value below a lower limit 1.5, the air gap between the third lens group and the fourth lens group becomes excessively small and hence, the illumination optical system cannot be inserted into the air gap.

Further, when |f_{b}/f_{w}| assumes a value above an upper limit 2.5, it is advantageous for ensuring the air gap between the third lens group and the fourth lens group for inserting the illumination optical system into the air gap. However, focal lengths of negative lenses of the first lens group and the third lens group become excessively small thus eventually increasing comatic aberration. Accordingly, it is not favorable to set |f_{b}/f_{w}| to the value above the upper limit 2.5.

The conditional expression (3) is a condition for properly keeping telecentricity of the optical system which performs focusing the third lens group and arranges a condensing lens directly in front of an image element. When |f_{T}/f₃| assumes a value below a lower limit 0.08, the focal length of the third lens group becomes excessively large and hence, a moving quantity of the third lens group in focusing becomes excessively large thus eventually making the lens group large-sized. Accordingly, it is not favorable to set |f_{T}/f₃| to the value below the lower limit 0.08.

Further, when |f_{T}/f₃| assumes a value above an upper limit 0.3, the moving quantity of the third lens group for focusing is decreased and hence, such setting of |f_{T}/f₃| to the value above the upper limit 0.3 is advantageous for making the lens system small-sized. However, in this case, it is difficult for the lens system to keep telecentricity and, at the same time, the spherical aberration is excessively increased. Accordingly, it is not favorable to set |f_{T}/f₃| to the value above the upper limit 0.3.

According to another aspect of the present invention, there is provided a zoom lens including a first lens group, a second lens group and a third lens group arranged sequentially from a projection plane side and capable of varying power between a short focal end and a long focal end thereof. The first lens group is constituted of three lenses consisting of one negative lens, one positive lens and one negative lens arranged sequentially from the projection plane side and has a negative power. The second lens group is constituted of three lenses in total consisting of one positive lens, one compound lens constituted of two lenses, and one compound lens constituted of two lenses arranged sequentially from the projection plane side and has a positive power. The third lens group is constituted of two lenses consisting of one negative lens and one positive lens arranged sequentially from the projection plane side and has a positive power. Further, in the zoom lens of the present invention, in varying power, the zoom lens is configured such that the first lens group and the second lens group are moved, while the third lens group is fixed. Further, the zoom lens is configured to move the third lens group for focusing.

In this zoom lens, a focal length can be varied by moving the first lens group and the second lens group. Further, in this zoom lens, focusing can be performed by moving the third lens group.

Further, according to the present invention, by designing the zoom lens which satisfies conditional expressions (4) to (6) described later, the zoom Jens can be configured to keep telecentricity due to an optical system ranging from the first lens group to the third Jens group. Here, keeping of telecentricity implies a state where a main light beam and an optical axis are arranged substantially parallel to each other (including inclination of approximately ±10°).

The zoom lens of the present invention may be configured to satisfy a following conditional expression (4).

0.6≦|f₂/f₁|≦1.3 (4)

f₁: combined focal length of the first lens group

f₂: combined focal length of the second lens group

The zoom lens of the present invention may be configured to satisfy a following conditional expression (5).

0.8≦|f_{b}/f_{w}|≦1.8 (5)

f_{b}: combined back focusing ranging from the first lens group to the third lens group

f_{w}: focal length at the short focal end

The zoom lens of the present invention may be configured to satisfy a following conditional expression (6).

0.08≦|fₜ/f₃|≦0.3 (6)

f₃: combined focal length of the third lens group

fₜ: focal length at the long focal end

A projector according to the present invention includes a zoom lens according to the present invention.

The above-mentioned conditional expressions (4) to (6) are explained hereinafter.

The conditional expression (4) is a condition for restricting the relationship between focal lengths of the first lens group and the second lens group which are moved for changing the focal lengths. When |f₂/f₁| assumes a value below a lower limit 0.6, the focal length of the first lens group becomes excessively large and hence, moving quantities of the first lens group and the second lens group for changing the focal lengths are increased thus eventually making the lens system large-sized. Accordingly, it is not favorable to set |f₂/f₁| to the value below the lower limit 0.6.

further, when |f₂/f₁| assumes a value above an upper limit 1.3, such setting of |f₂/f₁| is advantageous for making the lens small-sized. However, the focal length of the first lens group becomes excessively small and hence, spherical aberration generated in the first lens group becomes excessively large. Accordingly, it is difficult to favorably correct the spherical aberration.

The conditional expression (5) is a condition for ensuring an air gap for inserting an illumination optical system between the third lens group and the image element for properly ensuring a light quantity of a projected image by setting a combined back focusing ranging from the first lens group to the third lens group to a predetermined size. When |f_{b}/f_{w}| assumes a value below a lower limit 0.8, the air gap between the third lens group and the image element becomes excessively small and hence, the illumination optical system cannot be inserted into the air gap.

Further, when |f_{b}/f_{w}| assumes a value above an upper limit 1.8, it is advantageous for ensuring the air gap between the third lens group and the image element for inserting the illumination optical system in the air gap. However, focal lengths of negative lenses of the first lens group and the third lens group become excessively small thus eventually increasing comatic aberration. Accordingly, it is not favorable to set |f_{b}/f_{w}| to the value above the upper limit 1.8.

The conditional expression (6) is a condition for properly keeping telecentricity of the lens system which performs focusing the third lens group. When |fₜ/f₃| assumes a value below a lower limit 0.08, the focal length of the third lens group becomes excessively large and hence, a moving quantity of the third lens group in focusing becomes excessively large thus eventually making the lens group large-sized. Accordingly, it is not favorable to set |fₜ/f₃| to the value below the lower limit 0.08.

Further, when |fₜ/fₛ| assumes a value above an upper limit 0.3, the moving quantity of the third lens group for focusing is decreased and hence, such setting of |fₜ/f₃| to the value above the upper limit 0.3 is advantageous for making the lens system small-sized. However, in this case, it is difficult for the lens system to keep telecentricity and, at the same time, the spherical aberration is excessively decreased. Accordingly, it is not favorable to set |fₜ/f₃| to the value above the upper limit 0.3.

According to the present invention, it is possible to provide a projection-use zoom lens in which the number of constituting lenses is eight, that is, the smaller number of conventional constituting lenses. Further, according to the present invention, it is possible to provide a projection-use zoom lens which can easily keep telecentricity.

### BRIEF EXPLANATION OF THE DRAWINGS

FIG. 1 is an explanatory view showing the constitution of a lens of a numerical-value example 1 according to a first embodiment;

FIG. 2 is a view showing various aberrations at a short focal end of the numerical-value example 1 according to the first embodiment;

FIG. 3 is a view showing various aberrations at an intermediate focal position of the numerical-value example 1 according to the first embodiment;

FIG. 4 is a view showing various aberrations at a long focal end of the numerical-value example 1 according to the first embodiment;

FIG. 5 is an explanatory view showing the constitution of a lens of a numerical-value example 2 according to the first embodiment;

FIG. 6 is a view showing various aberrations at a short focal end of the numerical-value example 2 according to the first embodiment;

FIG. 7 is a view showing various aberrations at an intermediate focal position of the numerical-value example 2 according to the first embodiment;

FIG. 8 is a view showing various aberrations at a long focal end of the numerical-value example 2 according to the first embodiment;

FIG. 9 is an explanatory view showing the constitution of a lens of a numerical-value example 3 according to the first embodiment;

FIG. 10 is a view showing various aberrations at a short focal end of the numerical-value example 3 according to the first embodiment;

FIG. 11 is a view showing various aberrations at an intermediate focal position of the numerical-value example 3 according to the first embodiment;

FIG. 12 is a view showing various aberrations at a long focal end of the numerical-value example 3 according to the first embodiment;

FIG. 13 is an explanatory view showing the constitution of a lens of a numerical-value example 1 according to a second embodiment;

FIG. 14 is a view showing various aberrations at a short focal end of the numerical-value example 1 according to the second embodiment;

FIG. 15 is a view showing various aberrations at an intermediate focal position of the numerical-value example 1 according to the second embodiment;

FIG. 16 is a view showing various aberrations at a long focal end of the numerical-value example 1 according to the second embodiment;

FIG. 17 is an explanatory view showing the constitution of a lens of a numerical-value example 2 according to the second embodiment;

FIG. 18 is a view showing various aberrations at a short focal end of the numerical-value example 2 according to the second embodiment;

FIG. 19 is a view showing various aberrations at an intermediate focal position of the numerical-value example 2 according to the second embodiment;

FIG. 20 is a view showing various aberrations at a long focal end of the numerical-value example 2 according to the second embodiment;

FIG. 21 is an explanatory view showing the constitution of a lens of a numerical-value example 3 according to the second embodiment;

FIG. 22 is a view showing various aberrations at a short focal end of the numerical-value example 3 according to the second embodiment;

FIG. 23 is a view showing various aberrations at an intermediate focal position of the numerical-value example 3 according to the second embodiment;

FIG. 24 is a view showing various aberrations at a long focal end of the numerical-value example 3 according to the second embodiment;

FIG. 25 is an explanatory view showing the constitution of a lens of a numerical-value example 1 according to the third embodiment;

FIG. 26 is a view showing various aberrations at a short focal end of the numerical-value example 1 according to the third embodiment;

FIG. 27 is a view showing various aberrations at an intermediate focal position of the numerical-value example 1 according to the third embodiment;

FIG. 28 is a view showing various aberrations at a long focal end of the numerical-value example 1 according to the third embodiment;

FIG. 29 is an explanatory view showing the constitution of a lens of a numerical-value example 2 according to the third embodiment;

FIG. 30 is a view showing various aberrations at a short focal end of the numerical-value example 2 according to the third embodiment;

FIG. 31 is a view showing various aberrations at an intermediate focal position of the numerical-value example 2 according to the third embodiment;

FIG. 32 is a view showing various aberrations at a long focal end of the numerical-value example 2 according to the third embodiment;

FIG. 33 is an explanatory view showing the constitution of a lens of a numerical-value example 3 according to the third embodiment;

FIG. 34 is a view showing various aberrations at a short focal end of the numerical-value example 3 according to the third embodiment;

FIG. 35 is a view showing various aberrations at an intermediate focal position of the numerical-value example 3 according to the third embodiment; and

FIG. 36 is a view showing various aberrations at a long focal end of the numerical-value example 3 according to the third embodiment.

### DESCRIPTION OF THE PREFERRED EMBODIMENTS

### First Embodiment

First of all, a zoom lens of a first embodiment is explained. A zoom lens of the first embodiment is constituted of a first lens group, a second lens group, a third lens group and a fourth lens group arranged sequentially from a projection plane side and capable of varying power between a short focal end and a long focal end, wherein the first lens group is constituted of three lenses consisting of one negative lens, one positive lens and one negative lens arranged sequentially from the projection plane side and has a negative power, the second lens group is constituted of three lenses in total consisting of one compound lens, one positive lens and one compound lens arranged sequentially from the projection plane aide and has a positive power, the third lens group is constituted of one negative lens, and the fourth lens group is constituted of one positive lens and, in varying power, the zoom lens is configured such that the first lens group and the second lens group are moved, while the third lens group and the fourth lens group are fixed and, further, the zoom lens is configured to move the third lens group for focusing.

Next, a specific numerical-value example according to the first embodiment is explained.

(Constitution of Numerical-Value Example 1 According to First Embodiment)

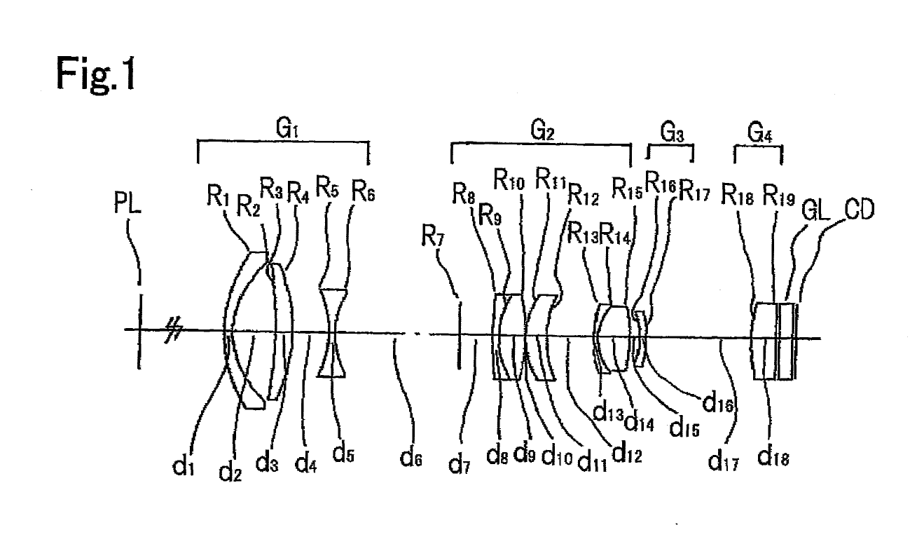

FIG. 1 shows the constitution of a zoom lens according to the numerical-value example 1 according to the first embodiment. In FIG. 1, symbol PL indicates a projection plane, symbol CD indicates an imaging element, symbol GL indicates a protection glass (here, including an optical filter or the like) of the imaging element or the like, symbol G₁ indicates a first lens group, symbol G₂ indicates a second lens group, symbol G₃ indicates a third lens group, and symbol G₄ indicates a fourth lens group. Here, symbol R₇ indicates a stop surface.

This zoom lens is constituted of a first lens group G₁, a second lens group Gₜᵣ a third lens group G₃ and a fourth lens group G₄ arranged sequentially from a projection plane PL side. The zoom lens can vary power between a short focal end and a long focal end.

The first lens group G₁ is constituted of three lenses consisting of one negative lens, one positive lens and one negative lens arranged sequentially from the projection plane side and has a negative power. Here, one lens which constitutes each lens group as a unit may be formed of, as described above, the compound lens equivalent to a single lens in terms of power. Here, the compound lens indicates a lens formed by cementing two or more single lenses.

The second lens group G₂ is constituted of one compound lens (R₈ to R₁₀), one positive lens (R₁₁ to R₁₂) and one compound lens (R₁₃ to R₁₅) arranged sequentially from the projection plane PL side and has a positive power. In the first embodiment, all compound lenses are respectively constituted of two lenses. With respect to the above-mentioned respective compound lenses, either or both of the compound lenses may be constituted of three or more lenses instead of two lenses. Further, the above-mentioned one positive lens (R₁₁ to R₁₂) may be constituted of one compound lens.

The third lens group G₃ is constituted of one negative lens. This negative lens may be also constituted of one compound lens having a negative power.

The fourth lens group G₄ is constituted of one positive lens. This positive lens may be also constituted of one compound lens having a positive power.

Accordingly, the zoom lens of the first embodiment is constituted of eight lenses in total. Here, as described above, the compound lens equivalent to the single lens in terms of power is counted as one lens.

In the first embodiment, in varying power, the zoom lens is configured such that the first lens group G₁ and the second lens group G₂ are moved, while the third lens group G₃ and the fourth lens group G₄ are fixed. Further, in the first embodiment, the zoom lens is configured to move the third lens group G₃ for focusing. A mechanism for moving such lens groups per se is substantially equal to a conventional corresponding lens group moving mechanism and hence, the detailed explanation of the lens group moving mechanism is omitted.

(Properties of Numerical-Value Example 1 According to First Embodiment)

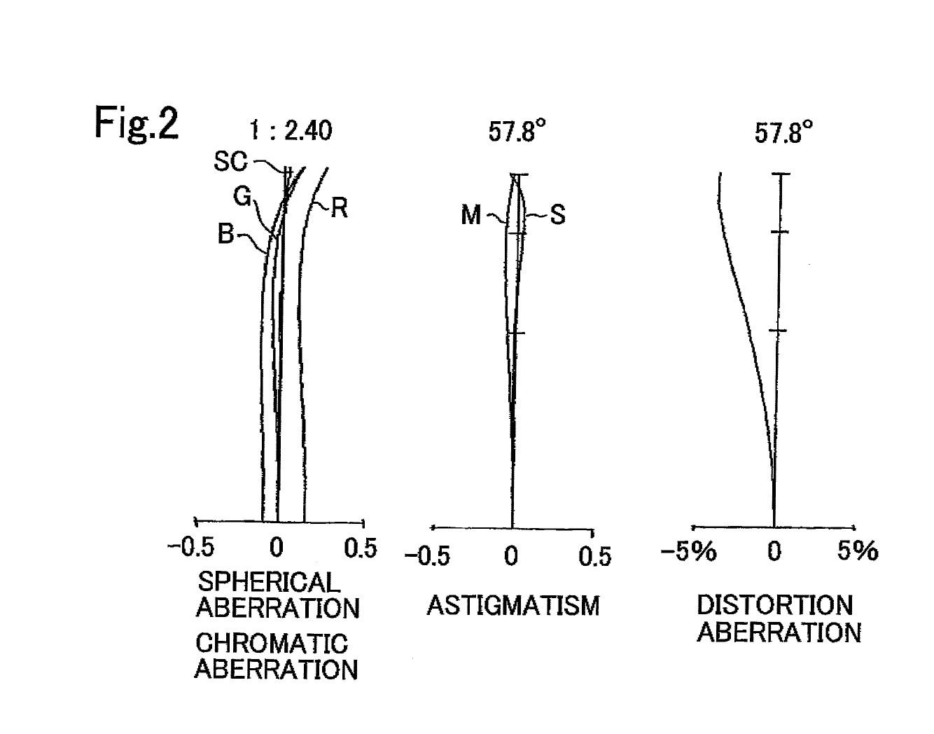

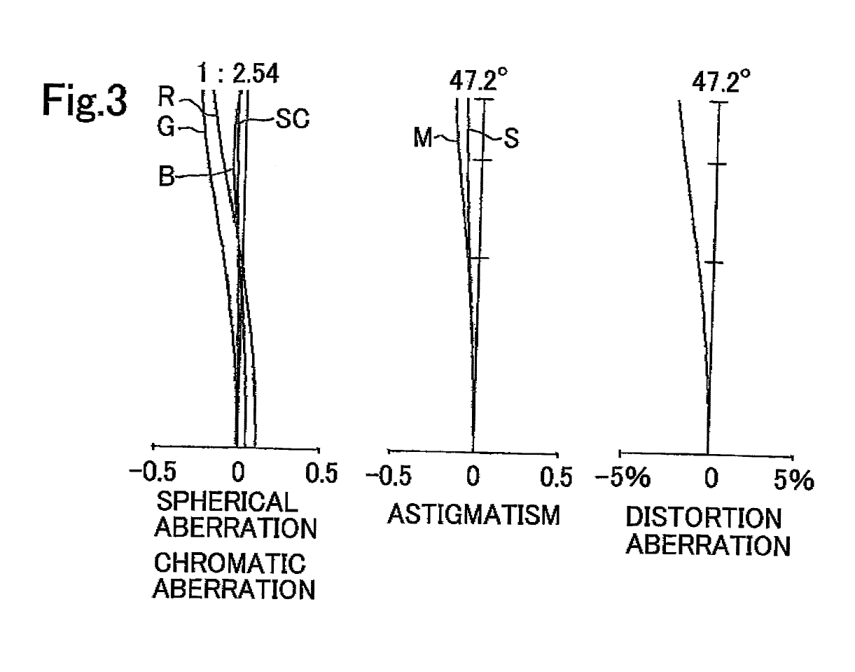

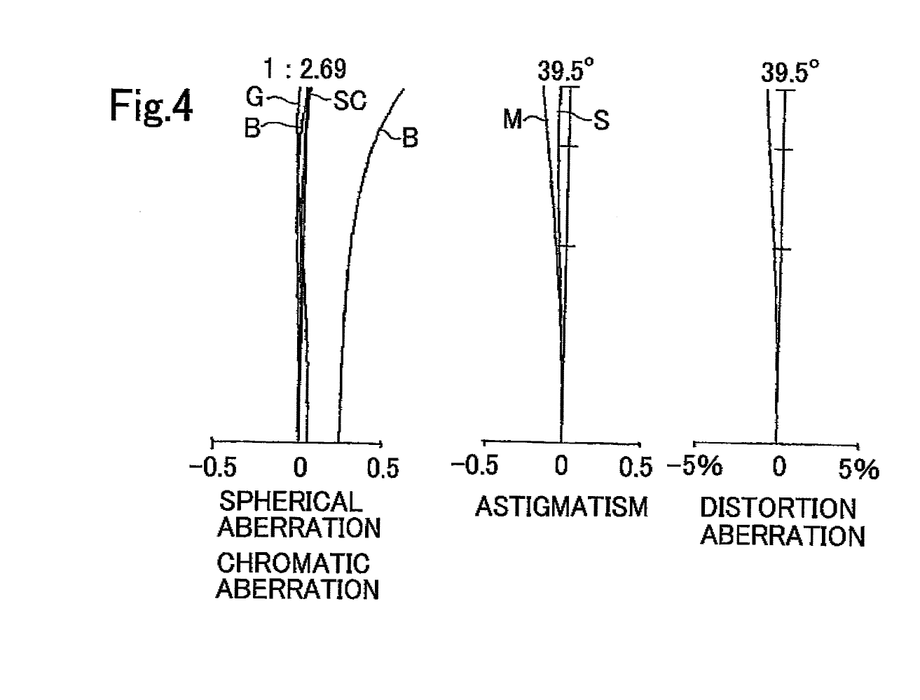

FIG. 2 to FIG. 4 show various aberrations of a numerical-value example 1. FIG. 2 shows various aberrations at a short focal end of the numerical-value example 1. FIG. 3 shows various aberrations at an intermediate focal position of the numerical-value example 1. FIG. 4 shows various aberrations at a long focal end of the numerical-value example 1.

In these drawings, symbols G, B, R in chromatic aberration expressed by spherical aberrations are, respectively, spherical chromatic aberrations corresponding to wavelengths of green, blue, red., and symbol SC indicates a sine condition unsatisfactory quantity.

In astigmatism, symbol S indicates sagittal and symbol M indicates meridional.

Further, various properties of the numerical-value example 1 are shown in Table 1,

TABLE 1

| | R | d | Nd | Vd |
|---|---|---|---|---|
| 1 | 44.107 | 2.00 | 1.80420 | 46.5 |
| 2 | 27.702 | 9.90 | | |
| 3 | −120.986 | 4.09 | 1.80420 | 46.5 |
| 4 | −49.048 | 8.53 | | |
| 5 | −31.433 | 1.50 | 1.48749 | 70.4 |
| 6 | 24.430 | 29.54 | | |
| 7 | ∞ | 8.00 | | |
| 8 | 141.659 | 1.50 | 1.83400 | 37.3 |
| 9 | 25.491 | 6.22 | 1.80420 | 46.5 |
| 10 | −58.563 | .10 | | |
| 11 | 24.917 | 5.00 | 1.83400 | 37.3 |
| 12 | 32.667 | 10.90 | | |
| 13 | 37.268 | 1.00 | 1.80518 | 25.4 |
| 14 | 15.165 | 7.49 | 1.48749 | 70.4 |
| 15 | −48.389 | 2.51 | | |
| 16 | −20.814 | 1.62 | 1.48749 | 70.4 |
| 17 | −28.034 | 25.00 | | |
| 18 | 49.471 | 5.48 | 1.58913 | 61.2 |
| 19 | ∞ | | | |

| | short focal | intermediate | long focal |
|---|---|---|---|
| | length end | focal length | length end |
| aperture ratio 1: | 2.40 | 2.54 | 2.69 |
| focal length | 18.882 | 23.525 | 28.199 |
| angle of projected | 57.8 | 47.2 | 39.5 |
| view (degree) | | | |
| variable interval | 29.550 | 20.776 | 14.874 |
| d 6 | | | |
| variable interval | 2.515 | 7.457 | 12.447 |
| d 15 | | | |
| incident angle to | 5.6 | 5.1 | 4.7 |
| element of principal ray | | | |
| (degree) (telecentric property) | | | |

| | |
|---|---|
| projector distance | 1000 |
| zooming power | 1.5 |
| fw | 18.882 |
| ft | 28.199 |
| f1 | −25.688 |
| f2 | 29.614 |
| f3 | −178.401 |
| fb | 32.309 |
| f2/f1 | −1.153 |
| fb/fw | 1.711 |
| ft/f3 | −0.158 |

In Table 1, symbol R indicates a radius of curvature, symbol d indicates a lens thickness or an air gap, symbol Nd indicates a refractive index of a d line (588 nm), and symbol Vd indicates Abbe's number of the d line (Abbe's number also indicated by symbol vd). The relationship between a subscript of the symbol R and the lens and the relationship between a subscript of the symbol d and the lens are set as shown in FIG. 1. Further, in Table 1, symbol f₁ indicates a focal length of the first lens group G₁, symbol f₂ indicates a focal length of the second lens group G₂, and symbol f₃ indicates a focal length of the third lens group G₃.

Further, in Table 1, symbol indicates a focal length at the short focal end, symbol f_{T} indicates a focal length at the long focal end, and symbol f_{b} indicates combined back focusing from the first lens group G₁ to the third lens group G₃.

Further, a projection distance is set to 1000 mm in the first embodiment.

With the use of the zoom lens of the numerical-value example 1, it is possible to provide a projection-use zoom lens constituted of lenses smaller in number than the conventional zoom lens, that is, 8 lenses. Here, as described above, the compound lens equivalent to a single lens in terms of power is counted as one lens. Further, in the zoom lens of this first embodiment, the focusing lens is constituted of the negative lens. Accordingly, the zoom lens has an advantage that, even in an optical system which arranges a condensing lens (that is, the fourth lens group G₄) directly frontward of the image element, the optical system can easily keep telecentricity. The telecentricity obtained, by this embodiment is as described in Table 1.

The zoom lens according to the first embodiment can be used as a projection-use lens for a projector.

(Constitution of Numerical-Value Example 2 According to First Embodiment)

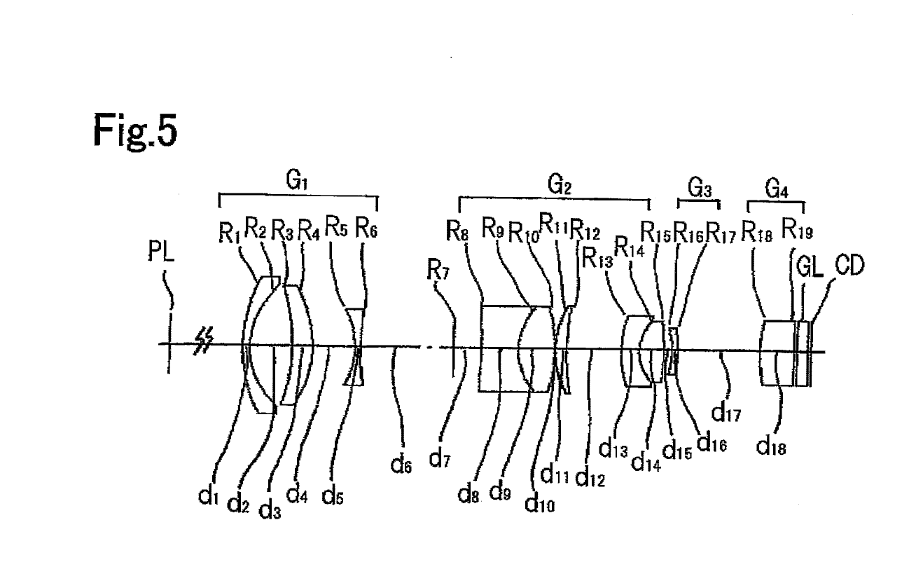

Next, the constitution of a zoom lens of the numerical-value example 2 according to the first embodiment is shown in FIG. 5, Here, in the explanation of the numerical-value example 2, with respect to the constitutional elements and properties substantially equal to the constitutional elements and the properties of the numerical-value example 1, the explanation is simplified by using the same symbols.

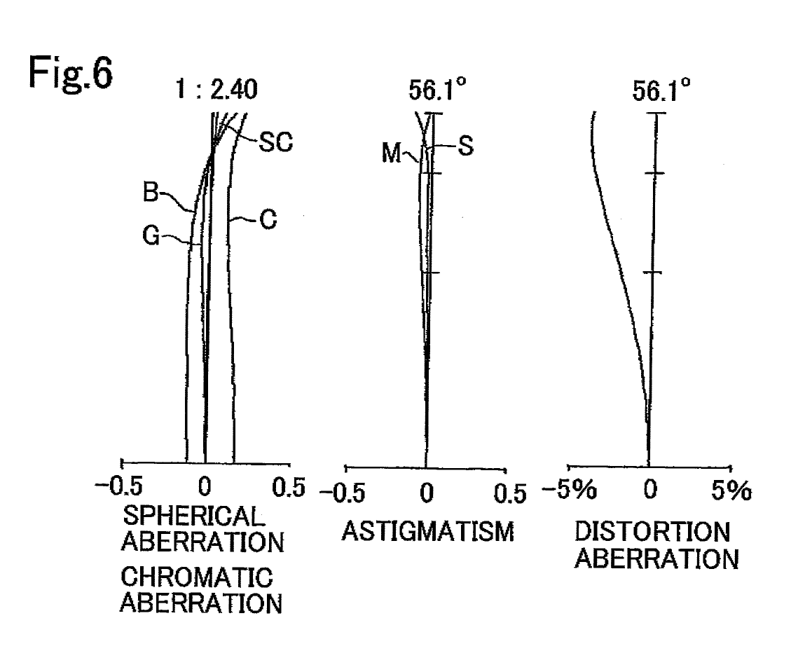

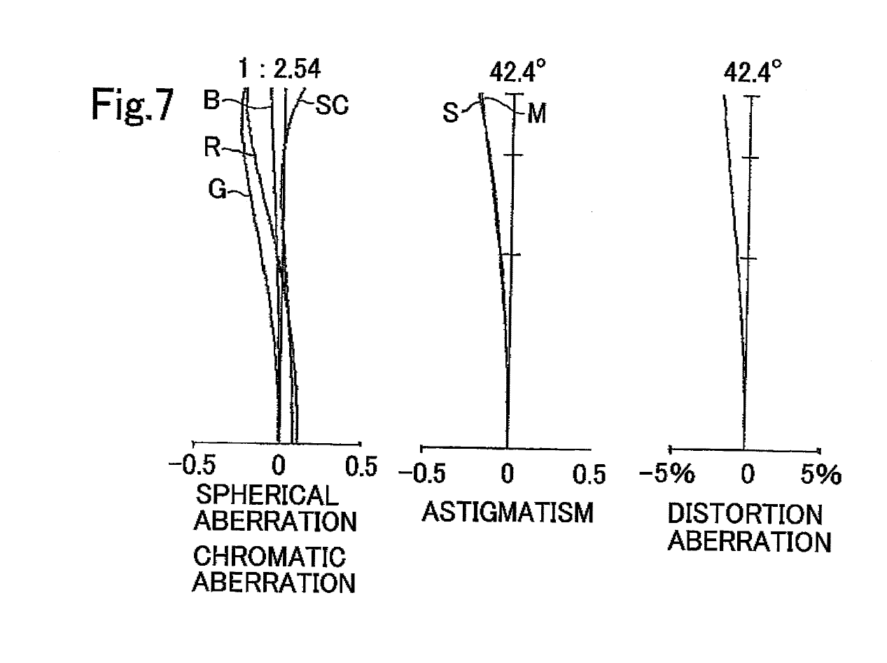

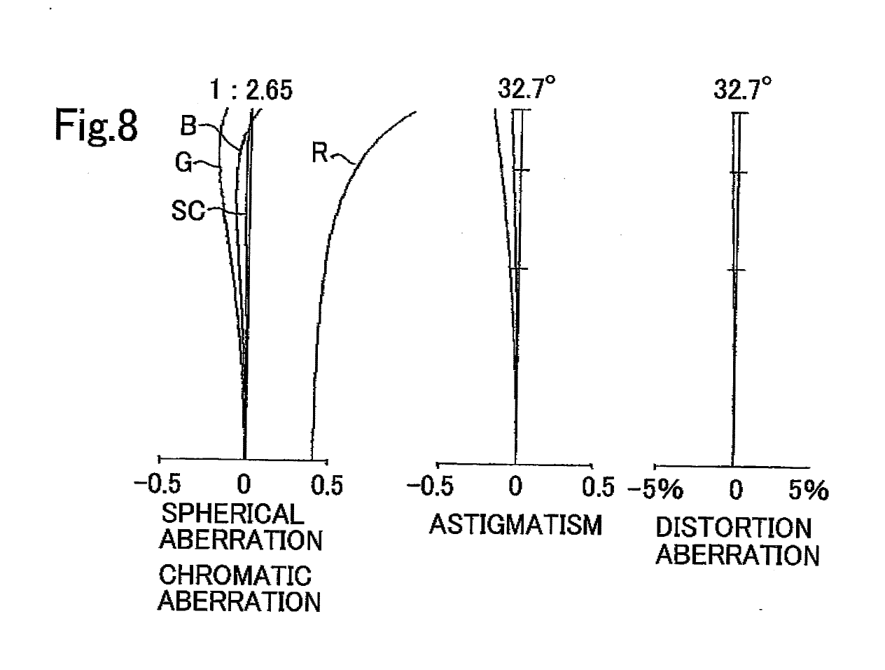

Various aberrations of the numerical-value example 2 are shown in FIG. 6 to FIG. 8. FIG. 6 shows various aberrations at a short focal end, FIG. 7 shows various aberrations at an intermediate focal position, and FIG. 8 shows various aberrations at a long focal end. Further, various properties of the numerical-value example 2 are shown in Table 2.

TABLE 2

| | R | d | Nd | Vd |
|---|---|---|---|---|
| 1 | 49.812 | 2.00 | 1.80420 | 46.50 |
| 2 | 27.023 | 11.68 | | |
| 3 | −63.436 | 5.55 | 1.80420 | 46.50 |
| 4 | −39.160 | 11.60 | | |
| 5 | −27.450 | 1.50 | 1.48749 | 70.45 |
| 6 | 96.853 | 25.47 | | |
| 7 | ∞ | 8.00 | | |
| 8 | −123.785 | 10.00 | 1.83400 | 37.34 |
| 9 | 22.046 | 10.00 | 1.80420 | 46.50 |
| 10 | −52.132 | .10 | | |
| 11 | 32.230 | 3.05 | 1.83400 | 37.34 |
| 12 | 95.673 | 15.00 | | |
| 13 | 39.478 | 4.80 | 1.80518 | 25.46 |
| 14 | 15.316 | 6.76 | 1.48749 | 70.45 |
| 15 | −99.727 | 2.25 | | |
| 16 | −29.264 | 1.63 | 1.48749 | 70.45 |
| 17 | −45.890 | 22.00 | | |
| 18 | 54.598 | 9.00 | 1.58913 | 61.25 |
| 19 | ∞ | | | |

| | short focal | intermediate | long focal |
|---|---|---|---|
| | length end | focal length | length end |
| aperture ratio 1: | 2.40 | 2.52 | 2.65 |
| focal length | 19.562 | 26.338 | 34.132 |
| angle of projected | 56.1 | 42.4 | 32.7 |
| view (degree) | | | |
| variable interval | 25.471 | 10.916 | 1.344 |
| d 6 | | | |
| variable interval | 2.259 | 8.623 | 15.992 |
| d 15 | | | |
| incident angle to | 6.0 | 5.6 | 5.3 |
| element of principal ray | | | |
| (degree) (telecentricity) | | | |

| | |
|---|---|
| projector distance | 1000 |
| zooming power | 1.75 |
| fw | 19.562 |
| ft | 34.132 |
| f1 | −232.147 |
| f2 | 31.784 |
| f3 | −170.660 |
| fb | 31.855 |
| f2/f1 | −0.989 |
| fb/fw | 1.628 |
| ft/f3 | −0.200 |

Other constitutions and advantages of the numerical-value example 2 are substantially equal to the constitutions and advantages of the numerical-value example 1 and hence, the more detailed explanation is omitted.

(Constitution of Numerical-Value Example 3 According to First Embodiment)

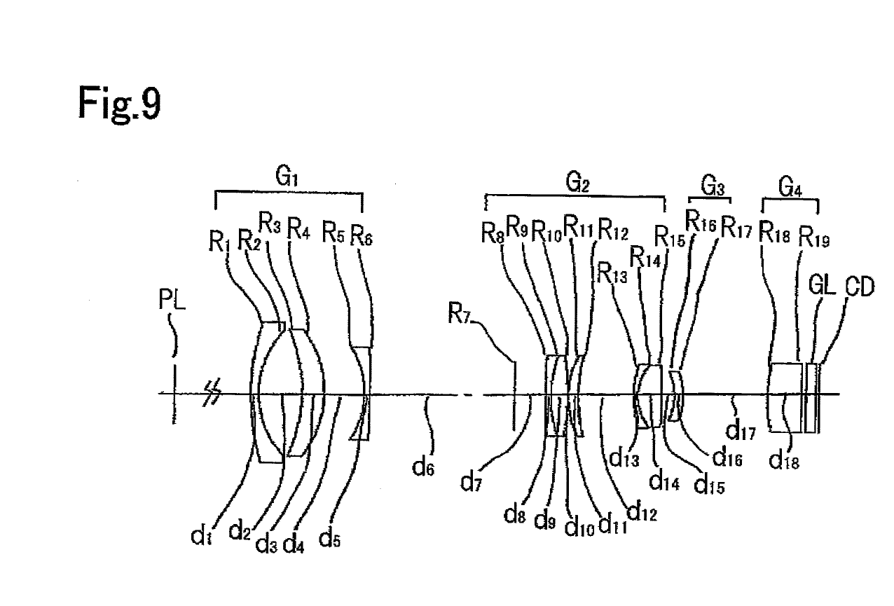

Next, FIG. 9 shows the constitution of a zoom lens of the numerical-value example 3 according to the first embodiment. Here, in the explanation of the numerical-value example 3, with respect to the constitutional elements and properties substantially equal to the constitutional elements and the properties of the numerical-value example 1, the explanation is simplified by using the same symbols.

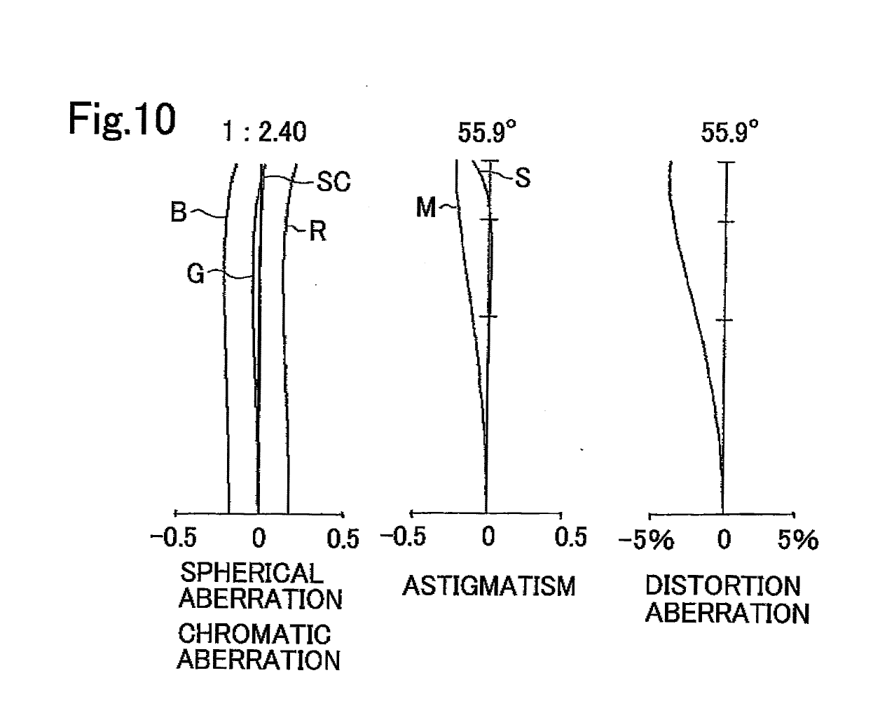

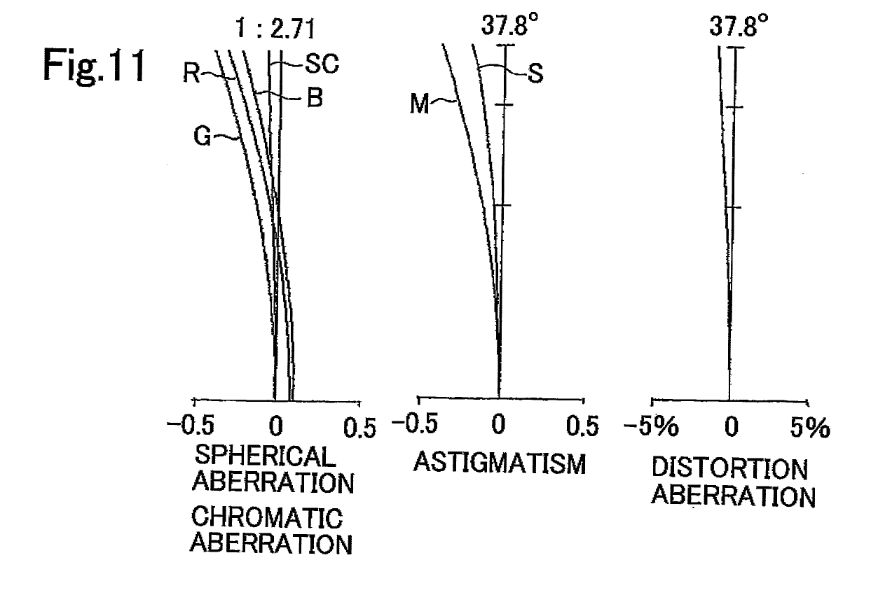

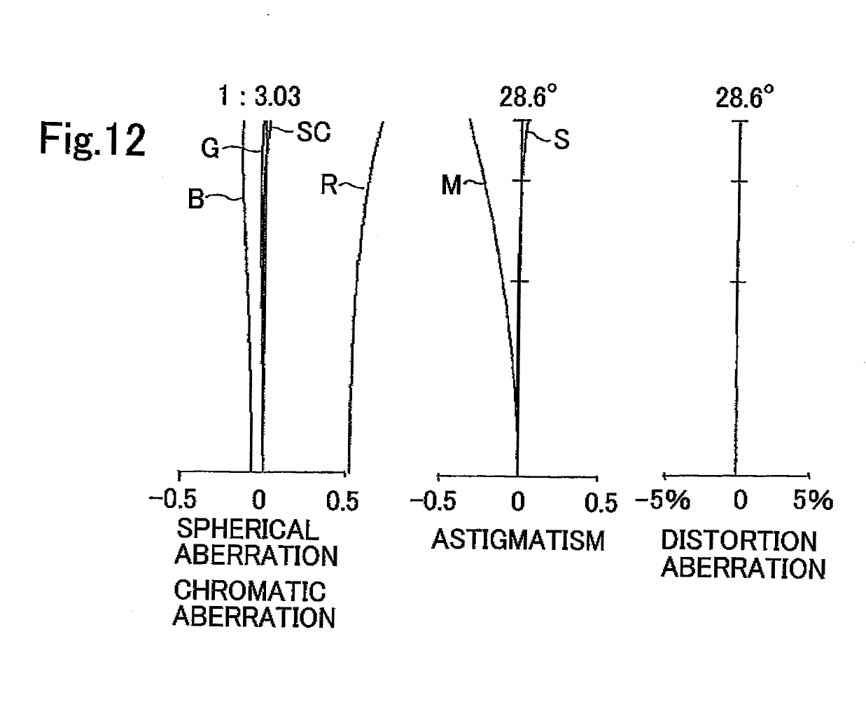

FIG. 10 to FIG. 12 show various aberrations of the numerical-value example 3. FIG. 10 shows various aberrations at a short focal end, FIG. 11 shows various aberrations at an intermediate focal position, and FIG. 12 shows various aberrations at a long focal end. Further, various properties of the numerical-value example 3 are shown in Table 3.

TABLE 3

| | R | d | Nd | Vd |
|---|---|---|---|---|
| 1 | 79.191 | 2.00 | 1.80420 | 46.50 |
| 2 | 29.385 | 11.51 | | |
| 3 | −51.989 | 5.66 | 1.80420 | 46.50 |
| 4 | −35.000 | 10.64 | | |
| 5 | −28.191 | 1.50 | 1.48749 | 70.45 |
| 6 | −243.798 | 38.35 | | |
| 7 | ∞ | 8.00 | | |
| 8 | 205.418 | 1.51 | 1.83400 | 37.34 |
| 9 | 39.209 | 4.45 | 1.80420 | 46.50 |
| 10 | −83.634 | .15 | | |
| 11 | 29.225 | 2.60 | 1.83400 | 37.34 |
| 12 | 52.209 | 15.00 | | |
| 13 | 39.659 | 1.00 | 1.80518 | 25.46 |
| 14 | 15.610 | 6.52 | 1.48749 | 70.45 |
| 15 | −123.274 | 3.29 | | |
| 16 | −19.842 | 2.22 | 1.48749 | 70.45 |
| 17 | −22.580 | 22.11 | | |
| 18 | 50.627 | 8.86 | 1.58913 | 61.25 |
| 19 | ∞ | | | |

| | short focal | intermediate | long focal |
|---|---|---|---|
| | length end | focal length | length end |
| aperture ratio 1: | 2.40 | 2.71 | 3.03 |
| focal length | 19.672 | 29.523 | 39.147 |
| angle of projected | 55.9 | 37.8 | 28.5 |
| view (degree) | | | |
| variable interval | 38.353 | 15.740 | 4.701 |
| d 6 | | | |
| variable interval | 3.299 | 12.874 | 32.396 |
| d 15 | | | |
| incident angle to | 6.0 | 5.0 | 4.2 |
| element of principal ray | | | |
| (degree) (telecentric property) | | | |

| | |
|---|---|
| projector distance | 1000 |
| zooming power | 2.0 |
| fw | 19.672 |
| ft | 39.147 |
| f1 | −38.165 |
| f2 | 35.536 |
| f3 | −456.590 |
| fb | 31.926 |
| f2/f1 | −0.931 |
| fb/fw | 1.623 |
| ft/f3 | −0.086 |

Other constitutions and advantages of the numerical-value example 3 are substantially equal to the constitutions and advantages of the numerical-value example 1 and hence, the more detailed explanation is omitted.

### Second Embodiment

Next, a zoom lens of a second embodiment is explained. A zoom lens of the second embodiment is constituted of a first lens group, a second lens group, a third lens group and a fourth lens group arranged sequentially from a projection plane side and capable of varying power between a short focal end and a long focal end, wherein the first lens group is constituted of three lenses consisting of one negative lens, one positive lens and one negative lens arranged sequentially from the projection plane side and has a negative power, the second lens group is constituted of three lenses in total consisting of one positive lens, one compound lens and one compound lens arranged sequentially from the projection plane side and has a positive power, the third lens group is constituted of one negative lens, and the fourth lens group is constituted of one positive lens and, in varying power, the zoom lens is configured such that the first lens group and, the second lens group are moved, while the third lens group and the fourth lens group are fixed and, further, the zoom lens is configured to move the third lens group is configured for focusing.

Next, a specific numerical-value example of a zoom lens according to the second embodiment is explained.

(Constitution of Numerical-Value Example 1 According to Second Embodiment)

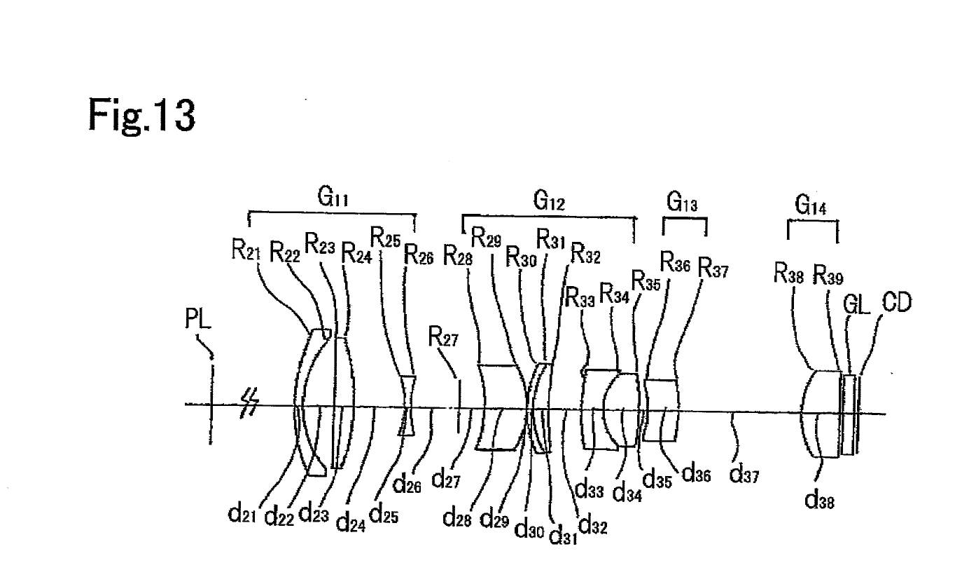

FIG. 13 shows the constitution of a zoom lens according to the numerical-value example 3 of the second embodiment. In FIG. 13, symbol PL indicates a projection plane, symbol GL indicates a protection glass (here, including an optical filter or the like) of the imaging element or the like, symbol CD indicates an imaging element, symbol G₁₁ indicates a first lens group, symbol G₁₂ indicates a second lens group, symbol G₁₃ indicates a third lens group, and symbol G₁₄ indicates a fourth lens group. Here, symbol R₂₇ indicates a stop surface.

This zoom lens is constituted of one first lens group G₁₁, a second lens group G₁₂, a third lens group G₁₃ and a fourth lens group G₁₄ arranged sequentially from a projection plane PL side. The zoom lens can vary power between a short focal end and a long focal end.

The first lens group G₁₁ is constituted of three lenses consisting of one negative lens, one positive lens and one negative lens arranged sequentially from the projection plane PL side and has a negative power. Here, one lens which constitutes each lens groups as a unit may be formed of, as described above, the compound lens equivalent to a single lens in terms of power. Here, the compound lens indicates a lens formed by cementing two or more single lenses.

The second lens group G₁₂ is constituted of one positive lens (R₂₈ to R₂₉), one compound lens (R₃₀ to R₃₂) and one compound lens (R₃₃ to R₃₅) from the projection plane PL side and has a positive power. In the second embodiment, all compound lenses are respectively constituted of two lenses. In the above-mentioned respective compound lenses, either or both of the compound lenses may be constituted of three or more lenses instead of two lenses. Further, the above-mentioned one positive lens (R₂₈ to R₂₉) may be constituted of a compound lens.

The third lens group G₁₃ is constituted of one negative lens. This negative lens may be also constituted of one compound lens having a negative power.

The fourth lens group G₁₄ is constituted of one positive lens. This positive lens may be also constituted of one compound lens having a positive power.

Accordingly, the zoom lens of the second embodiment is constituted of eight lenses in total. Here, as described above, the compound lens equivalent to the single lens in terms of power is counted as one lens.

In the second embodiment, in varying power of the zoom lens, the zoom lens is configured such that the first lens group G₁₁ and the second lens group G₁₂ are moved, while the third lens group G₁₃ and the fourth lens group G₁₄ are fixed. Further, in the second embodiment, the zoom lens is configured to move the third lens group G₁₃ for focusing. A moving mechanism per se of such lens group is substantially equal to a conventional moving mechanism of a lens group and hence, the detailed explanation of the moving mechanism is omitted.

(Properties of Numerical-Value Example 1 According to Second Embodiment)

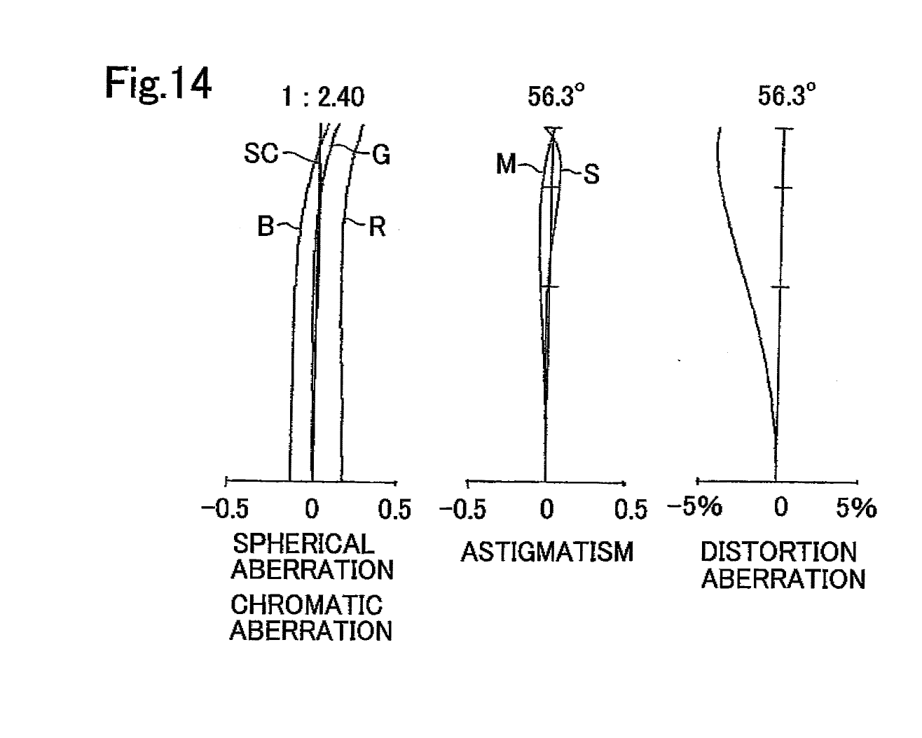

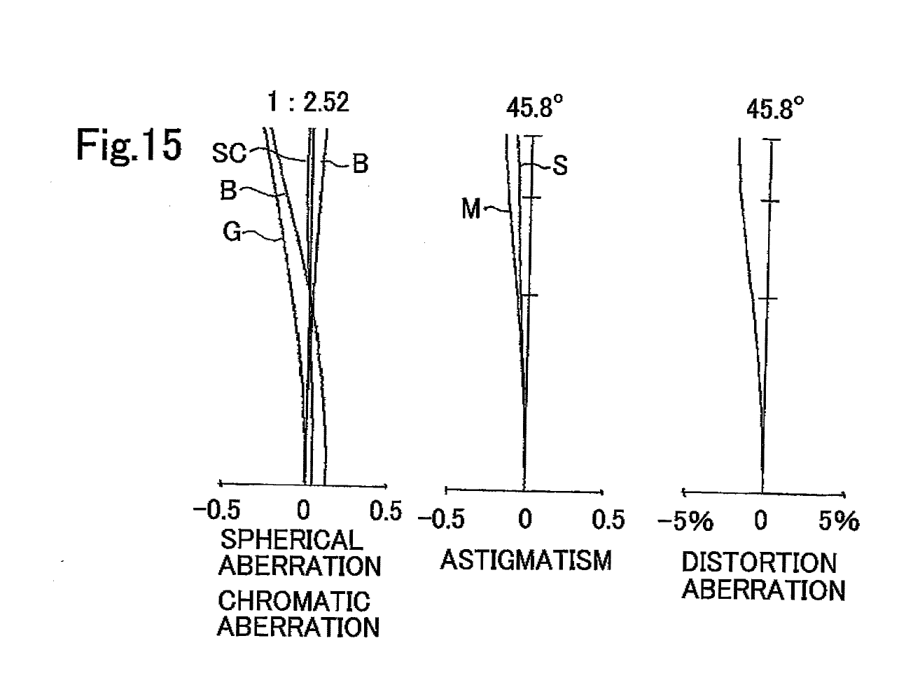

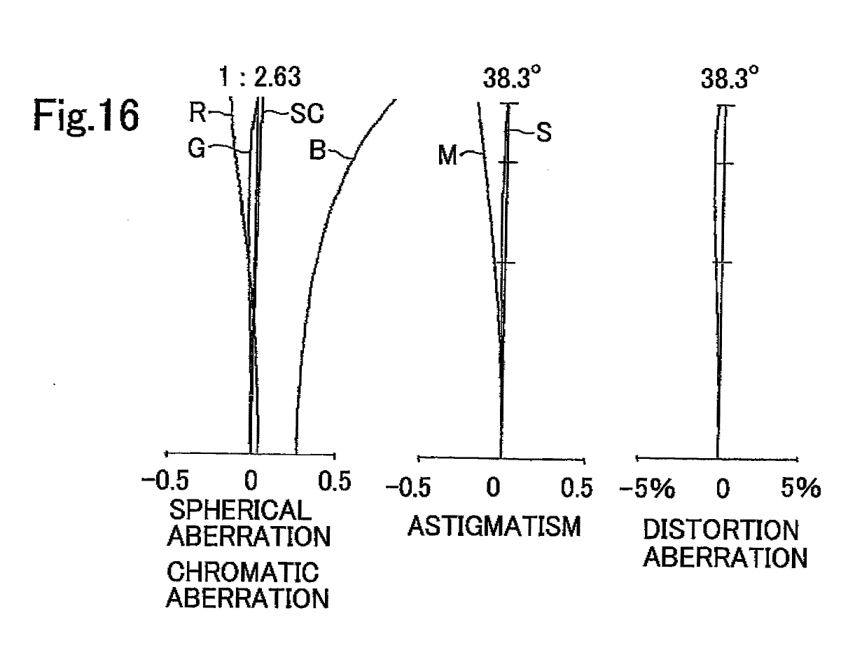

FIG. 14 to FIG. 16 show various aberrations of a numerical-value example 1. FIG. 14 shows various aberrations at a short focal end of the numerical-value example 1. FIG. 15 shows various aberrations at an intermediate focal position of the numerical-value example 1. FIG. 16 shows various aberrations at a long focal end of the numerical-value example 1.

In these drawings, symbols G, B, R in chromatic aberration expressed by spherical aberrations are, respectively, spherical chromatic aberrations corresponding to wavelengths of green, blue, red, and symbol SC indicates a sine condition unsatisfactory quantity.

In astigmatism, symbol S indicates sagittal and symbol M indicates meridional.

Further, various properties of the numerical-value example 1 are shown in Table 4.

TABLE 4

| | R | d | Nd | Vd |
|---|---|---|---|---|
| 1 | 53.422 | 2.00 | 1.80420 | 46.50 |
| 2 | 31.362 | 7.05 | | |
| 3 | 4655.051 | 4.72 | 1.83400 | 37.34 |
| 4 | −64.540 | 12.17 | | |
| 5 | −24.417 | 1.50 | 1.80420 | 46.50 |
| 6 | 35.805 | 11.77 | | |
| 7 | ∞ | 6.25 | | |
| 8 | −39.319 | 10.00 | 1.83400 | 37.34 |
| 9 | −27.573 | .10 | | |
| 10 | 30.844 | 1.52 | 1.78472 | 25.70 |
| 11 | 26.891 | 3.76 | 1.83400 | 37.34 |
| 12 | 107.402 | 7.79 | | |
| 13 | 65.331 | 5.00 | 1.80518 | 25.46 |
| 14 | 14.524 | 8.81 | 1.64250 | 57.96 |
| 15 | −60.800 | 2.16 | | |
| 16 | −26.076 | 7.35 | 1.59551 | 39.23 |
| 17 | −41.012 | 29.41 | | |
| 18 | 24.036 | 9.00 | 1.58913 | 61.25 |
| 19 | ∞ | | | |

| | short focal | intermediate | long focal |
|---|---|---|---|
| | length end | focal length | length end |
| aperture ratio 1: | 2.40 | 2.52 | 2.63 |
| focal length | 19.649 | 24.473 | 29.316 |
| angle of projected | 56.3 | 45.8 | 38.3 |
| view (degree) | | | |
| variable interval | 11.774 | 7.042 | 3.880 |
| d 26 | | | |
| variable interval | 2.166 | 7.990 | 13.784 |
| d 35 | | | |
| incident angle to | 6.7 | 7.0 | 7.3 |
| element of principal ray | | | |
| (degree) (telecentric property) | | | |

| | |
|---|---|
| projector distance | 1000 |
| zooming power | 1.5 |
| fw | 19.649 |
| ft | 29.316 |
| f1 | −18.524 |
| f2 | 24.024 |
| f3 | −146.580 |
| fb | 40.855 |
| f2/f1 | −1.297 |
| fb/fw | 2.079 |
| ft/f3 | −0.200 |

In Table 4, symbol R indicates a radius of curvature, symbol d indicates a lens thickness or an air gap, symbol Nd indicates a refractive index of a d line (588 nm), and symbol Vd indicates Abbe's number of the d line (Abbe's number also indicated by symbol vd). The relationship between a subscript of the symbol R and the lens and the relationship between a subscript of the symbol d and the lens are set as shown in FIG. 13. Further, in Table 4, symbol f₁ indicates a focal length of the first lens group G₁₁, symbol f₂ indicates a focal length of the second lens group G₁₂, and symbol f₃ indicates a focal length of the third lens group G₁₃.

Further, in Table 4, symbol f_{w} indicates a focal length at the short focal end, symbol f_{T} indicates a focal length at the long focal end, and symbol f_{b} indicates combined back focusing from the first lens group G₁₁ to the third lens group G₁₃.

Further, a projection distance is set to 1000 mm in the second embodiment.

With the use of the zoom lens of the numerical-value example 1, it is possible to provide a projection-use zoom lens constituted of lenses smaller in number than the conventional zoom lens, that is, 8 lenses. Here, as described above, the compound lens equivalent to a single lens in terms of power is counted as one lens. Further, in the zoom lens of this numerical-value example 1, the focusing lens is constituted of the negative lens. Accordingly, the zoom lens has an advantage that, even in an optical system which arranges a condensing lens (that is, the fourth lens group G₁₄) directly frontward of the image element, the optical system can easily keep telecentricity. The telecentricity obtained by this embodiment is as described in Table 1.

The zoom lens according to the second embodiment can be used as a projection-use lens for a projector.

(Constitution of Numerical-Value Example 2 According to Second Embodiment)

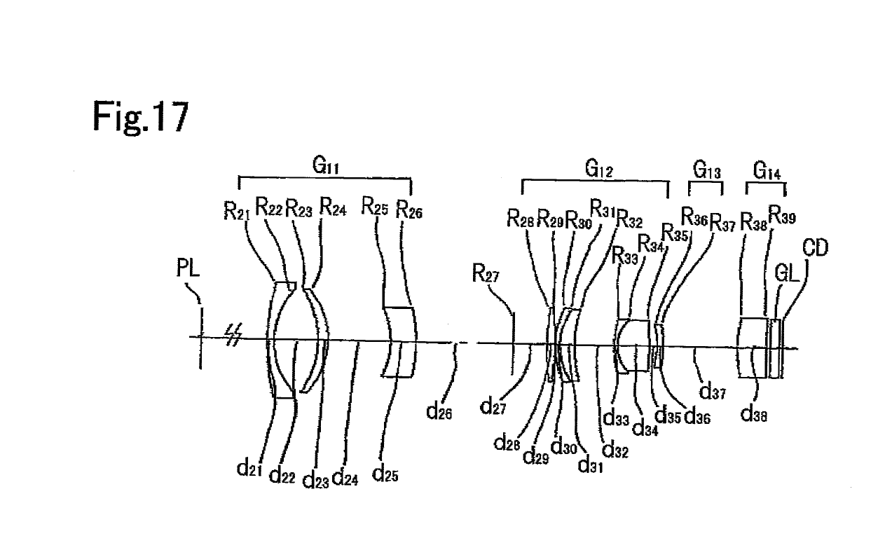

Next, FIG. 17 shows the constitution of a zoom lens of the numerical-value example 2 according to the second embodiment. Here, in the explanation of the numerical-value example 2, with respect to the constitutional elements and properties substantially equal to the constitutional elements and the properties of the numerical-value example 1, the explanation is simplified by using the same symbols.

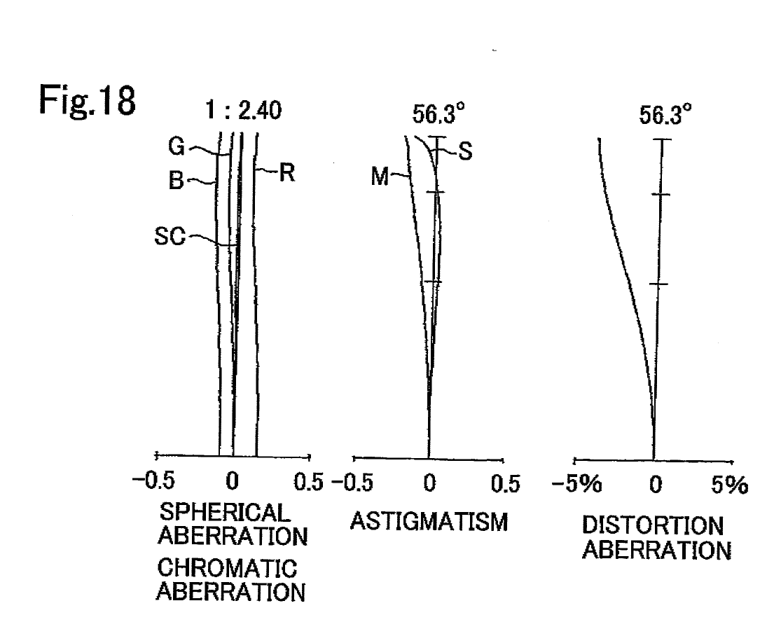

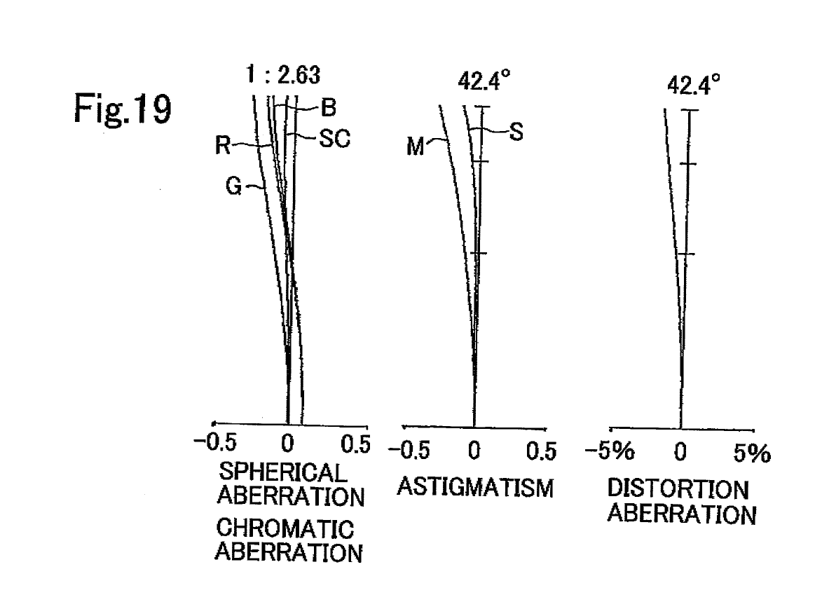

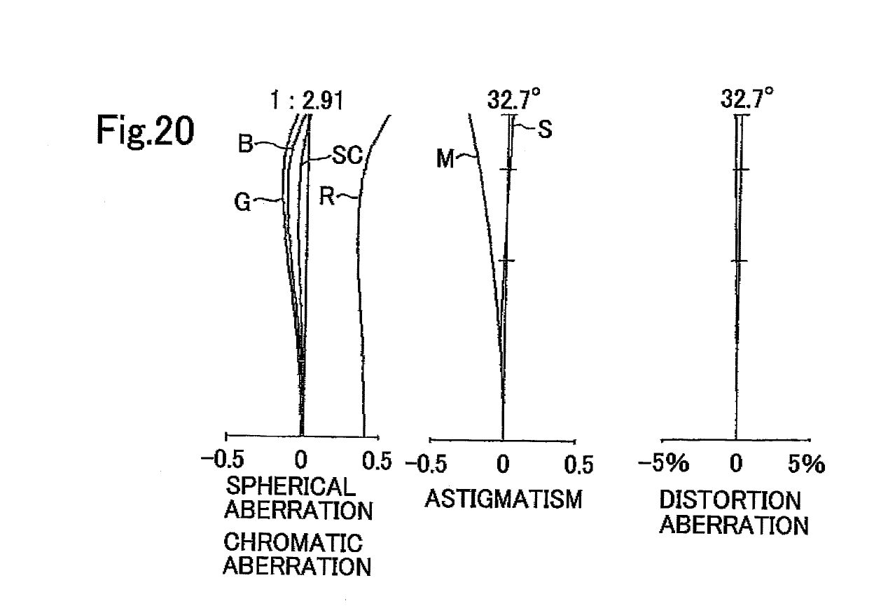

FIG. 18 to FIG. 20 show various aberrations of the numerical-value example 2. FIG. 18 shows various aberrations at a short focal end, FIG. 19 shows various aberrations at an intermediate focal position, and FIG. 20 shows various aberrations at a long focal end. Further, various properties of the numerical-value example 2 are shown in Table 5.

TABLE 5

| | R | d | Nd | Vd |
|---|---|---|---|---|
| 1 | 93.331 | 2.0000 | 1.83400 | 37.34 |
| 2 | 29.640 | 13.20 | | |
| 3 | −36.805 | 2.88 | 1.84666 | 23.83 |
| 4 | −31.060 | 18.72 | | |
| 5 | −29.859 | 8.00 | 1.69350 | 53.54 |
| 6 | −61.351 | 29.21 | | |
| 7 | ∞ | 10.00 | | |
| 8 | 114.321 | 2.48 | 1.80420 | 46.50 |
| 9 | −114.606 | .10 | | |
| 10 | 31.687 | 1.50 | 1.53172 | 48.83 |
| 11 | 25.212 | 4.34 | 1.80420 | 46.50 |
| 12 | 51.363 | 12.01 | | |
| 13 | 41.094 | 1.00 | 1.80518 | 25.46 |
| 14 | 13.966 | 9.41 | 1.51823 | 58.96 |
| 15 | −195.160 | 2.47 | | |
| 16 | −29.699 | 2.03 | 1.84666 | 23.83 |
| 17 | −36.155 | 22.00 | | |
| 18 | 49.338 | 9.00 | 1.58913 | 61.25 |
| 19 | ∞ | | | |

| | short focal | intermediate | long focal |
|---|---|---|---|
| | length end | focal length | length end |
| aperture ratio 1: | 2.40 | 2.63 | 2.91 |
| focal length | 19.547 | 26.299 | 34.155 |
| angle of projected | 56.3 | 42.4 | 32.7 |
| view (degree) | | | |
| variable interval | 29.220 | 11.716 | 3.880 |
| d 26 | | | |
| variable interval | 2.166 | 0.100 | 13.784 |
| d 35 | | | |
| incident angle to | 5.7 | 5.7 | 4.9 |
| element of principal ray | | | |
| (degree) (telecentric property) | | | |

| | |
|---|---|
| projector distance | 1000 |
| zooming power | 1.75 |
| fw | 19.547 |
| ft | 34.155 |
| f1 | −36.371 |
| f2 | 35.278 |
| f3 | −227.691 |
| fb | 32.000 |
| f2/f1 | −0.970 |
| fb/fw | 1.637 |
| ft/f3 | −0.150 |

Other constitutions and advantages of the numerical-value example 2 are substantially equal to the constitutions and, advantages of the numerical-value example 1 and hence, the more detailed explanation is omitted.

(Constitution of Numerical-Value Example 3 According to Second Embodiment)

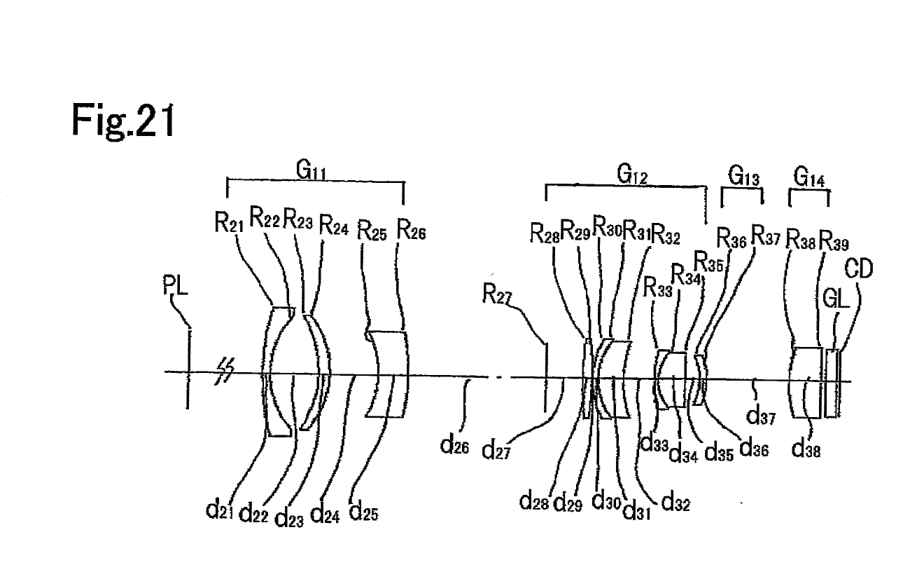

Next, FIG. 21 shows the constitution of a zoom lens of the numerical-value example 3 according to the second embodiment. Here, in the explanation of the numerical-value example 3, with respect to the constitutional elements and properties substantially equal to the constitutional elements and the properties of the numerical-value example 1, the explanation is simplified by using the same symbols.

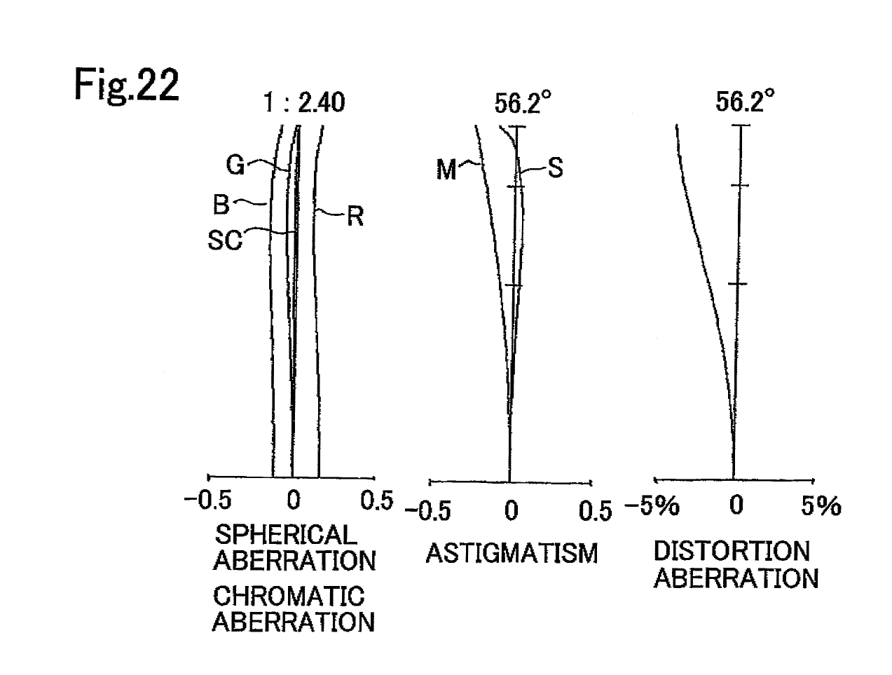

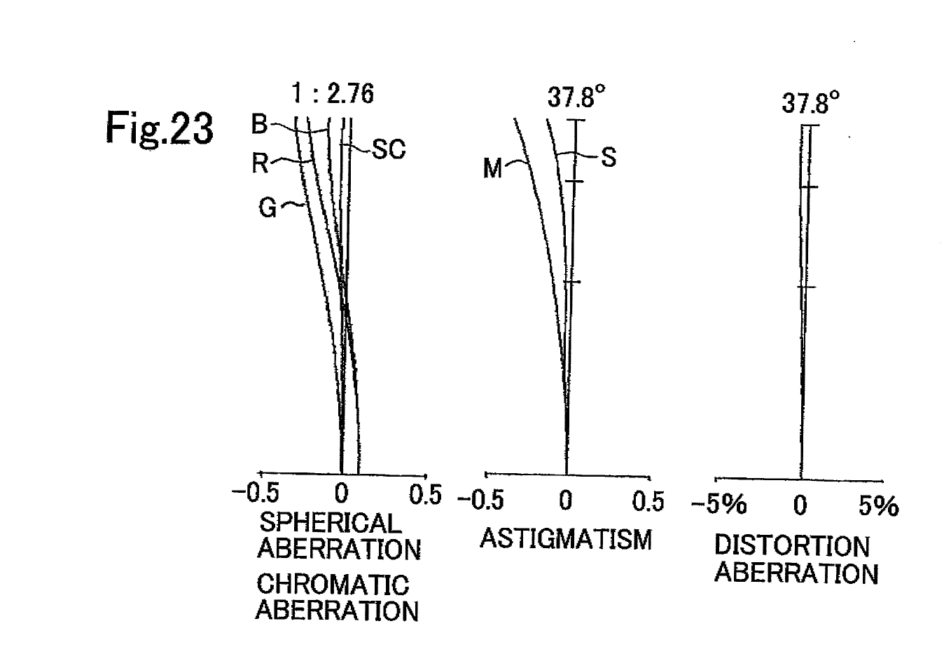

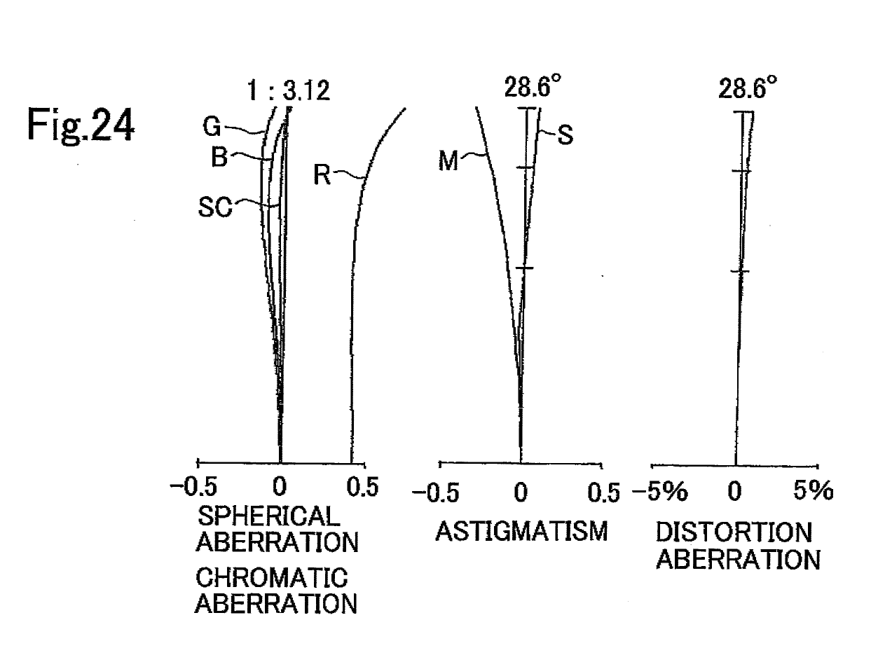

FIG. 22 to FIG. 24 show various aberrations of the numerical-value example 3. FIG. 22 shows various aberrations at a short focal end, FIG. 23 shows various aberrations at an intermediate focal position, and FIG. 24 shows various aberrations at a long focal end. Further, various properties of the numerical-value example 3 are shown in Table 6.

TABLE 6

| | R | d | Nd | Vd |
|---|---|---|---|---|
| 1 | 84.522 | 2.0 | 1.83400 | 37.34 |
| 2 | 29.492 | 12.95 | | |
| 3 | −38.598 | 3.03 | 1.84666 | 23.83 |
| 4 | −32.059 | 13.21 | | |
| 5 | −30.942 | 8.00 | 1.58913 | 61.25 |
| 6 | −66.740 | 36.97 | | |
| 7 | ∞ | 10.00 | | |
| 8 | 130.736 | 2.56 | 1.80420 | 46.50 |
| 9 | −92.881 | .10 | | |
| 10 | 28.248 | 1.50 | 1.53172 | 48.83 |
| 11 | 21.278 | 6.75 | 1.80420 | 46.50 |
| 12 | 37.032 | 8.43 | | |
| 13 | 47.725 | 1.00 | 1.80518 | 25.46 |
| 14 | 13.505 | 7.36 | 1.51823 | 58.96 |
| 15 | −315.881 | 3.66 | | |
| 16 | −19.104 | 1.84 | 1.84666 | 23.83 |
| 17 | −21.160 | 22.00 | | |
| 18 | 35.522 | 9.00 | 1.58913 | 61.25 |
| 19 | ∞ | | | |

| | short focal | intermediate | long focal |
|---|---|---|---|
| | length end | focal length | length end |
| aperture ratio 1: | 2.40 | 2.76 | 3.12 |
| focal length | 19.623 | 29.483 | 39.132 |
| angle of projected | 56.2 | 37.8 | 28.6 |
| view (degree) | | | |
| variable interval | 36.973 | 12.158 | 0.100 |
| d 26 | | | |
| variable interval | 3.668 | 12.917 | 21.926 |
| d 35 | | | |
| incident angle to | 2.7 | 2.2 | 1.3 |
| element of principal ray | | | |
| (degree) (telecentric property) | | | |

| | |
|---|---|
| projector distance | 1000 |
| zooming power | 2.0 |
| fw | 19.623 |
| ft | 39.132 |
| f1 | −42.062 |
| f2 | 36.633 |
| f3 | −391.314 |
| fb | 32.505 |
| f2/f1 | −0.871 |
| fb/fw | 1.656 |
| ft/f3 | −0.100 |

Other constitutions and advantages of the numerical-value example 3 are substantially equal to the constitutions and advantages of the numerical value example 1 and hence, the more detailed explanation is omitted.

### Embodiment 3

First of all, a zoom lens of a third embodiment is explained. A zoom lens of the third embodiment is constituted of a first lens group, a second lens group and a third lens group arranged sequentially from a projection plane side. The zoom lens can vary power between a short focal end and a long focal end, wherein the first lens group is constituted of three lenses consisting of one negative lens, one positive lens and one negative lens arranged sequentially from the projection plane side and has a negative power, the second lens group is constituted of three lenses in total consisting of one positive lens, one compound lens constituted of two lenses, and one compound lens constituted of two lenses sequentially from the projection plane side and has a positive power, and the third lens group is constituted of two lenses consisting of one negative lens and one positive lens arranged sequentially from the projection plane side and has a positive power and, in varying power, the zoom lens is configured such that the first lens group and the second lens group are moved, while the third lens group is fixed and, further, the zoom lens is configured to move the third lens group for focusing.

Next, a specific numerical-value example of a zoom lens according to the third embodiment is explained.

(Constitution of Numerical-Value Example 1 According to Third Embodiment)

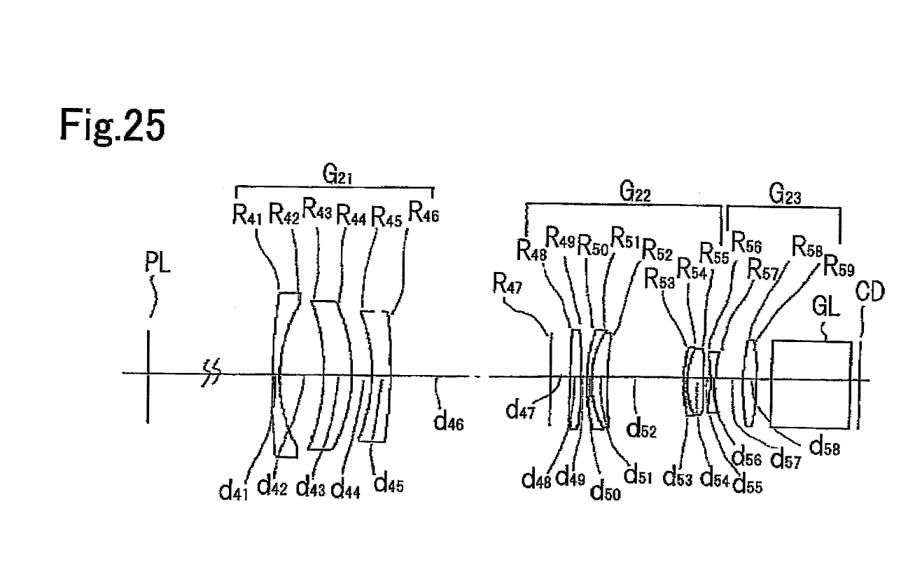

FIG. 25 shows the constitution of a zoom lens according to the numerical-value example 1 of the third embodiment. In FIG. 25, symbol PL indicates a projection plane, symbol GL indicates a protection glass of an imaging element, symbol CD indicates the imaging element, symbol G₂₁ indicates a first lens group, symbol G₂₂ indicates a second lens group and symbol G₂₃ indicates a third lens group. Here, symbol R₄₇ indicates a stop surface.

This zoom lens is constituted of a first lens group G₂₁, a second lens group G₂₂ and a third lens group G₂₃ arranged sequentially from a projection plane PL side. The zoom lens can vary power between a short focal end and a long focal end.

The first lens group G₂₁ is constituted of three lenses consisting of one negative lens, one positive lens and one negative lens arranged sequentially from the projection plane PL side and has a negative power. Here, one lens which constitutes each lens group as a unit may be formed of a single lens or a compound lens without particularly mentioned. Here, the compound lens indicates a lens formed by cementing two or more single lenses.

The second lens group G₂₂ is constituted of one positive lens and two compound lenses (lens between R₅₀ and R₅₅) arranged sequentially from the projection plane PL side and has a positive power. In the third embodiment, all compound lenses are respectively constituted of two single lenses.

The third lens group G₂₃ is constituted of one negative lens and one positive lens arranged sequentially from the projection plane FL side and has a positive power. In the third embodiment, these lenses are constituted of single lenses. However, these lenses may be constituted of compound lenses.

As described above, the zoom lens of the third embodiment is constituted of eight lenses in total. Here, the compound lens equivalent to the single lens in terms of power is counted as one lens.

In the third embodiment, in varying power of the zoom lens, the zoom lens is configured such that the first lens group G₂₁ and the second lens group G₂₂ are moved, while the third lens group G₂₃ is fixed. Further, in the third embodiment, the zoom lens is configured to move the third lens group G₂₃ for focusing. A moving mechanism per se of such lens group is substantially equal to a conventional moving mechanism of a lens group and hence, a detailed explanation of the moving mechanism is omitted.

(Properties of Numerical-Value Example 1 According to Third Embodiment)

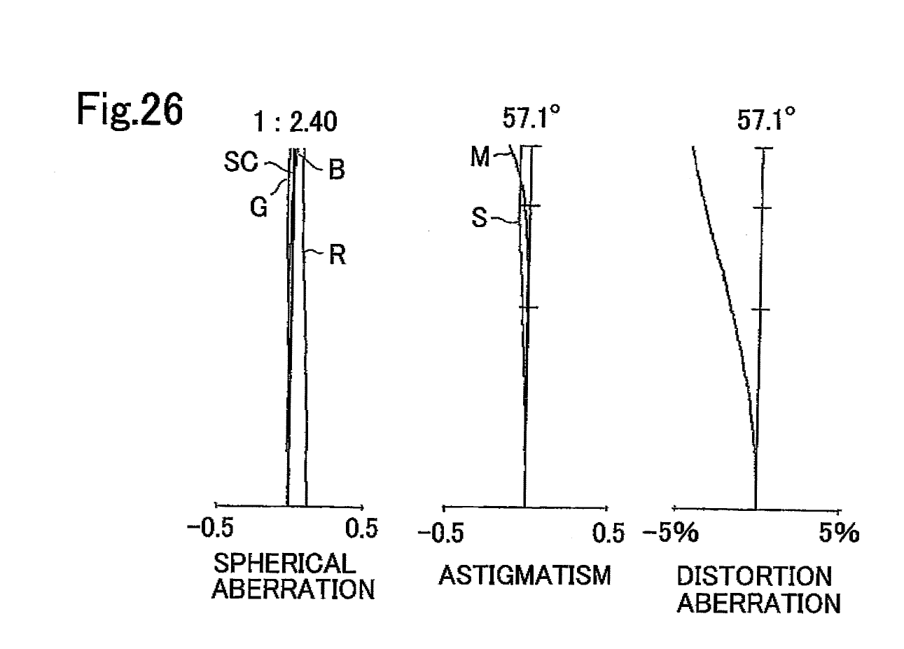

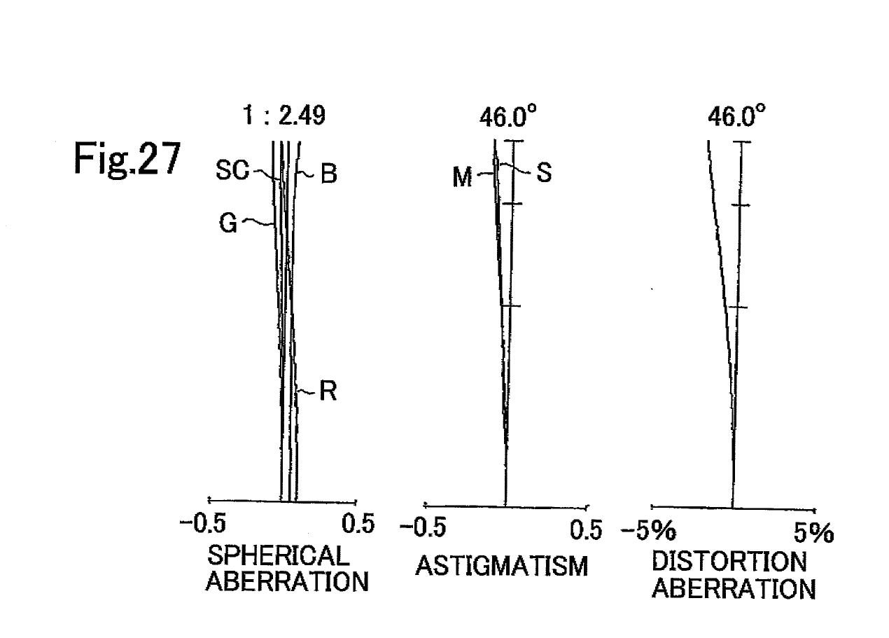

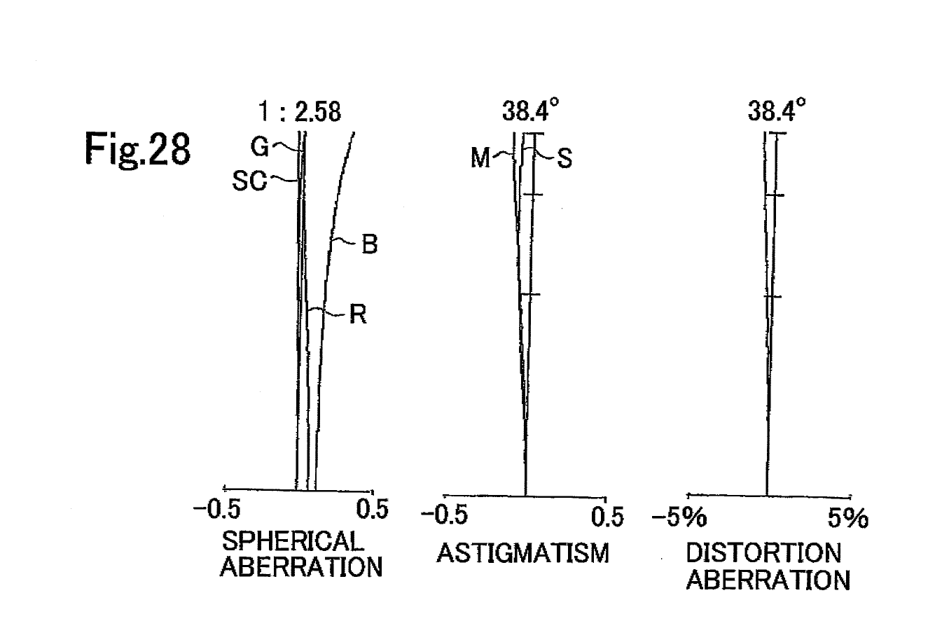

FIG. 26 to FIG. 28 show various aberrations of a numerical-value example 1. FIG. 26 shows various aberrations at a short focal end of the numerical-value example 1, FIG. 27 shows various aberrations at an intermediate focal position of the numerical-value example 1, and FIG. 28 shows various aberrations at a long focal end of the numerical-value example 1.

In these drawings, symbols G, B, R in chromatic aberration expressed by spherical aberrations are, respectively, spherical chromatic aberrations corresponding to wavelengths of green, blue, red, and symbol SC indicates a sine condition unsatisfactory quantity.

In astigmatism, symbol S indicates sagittal and symbol M indicates meridional.

Further, various properties of the numerical-value example 1 are shown in Table 7.

TABLE 7

| | R | d | Nd | Vd |
|---|---|---|---|---|
| 1 | 134.090 | 2.00 | 1.80420 | 46.50 |
| 2 | 29.529 | 12.40 | | |
| 3 | −42.882 | 8.00 | 1.80518 | 25.46 |
| 4 | −33.046 | 5.85 | | |
| 5 | −34.972 | 5.00 | 1.48749 | 70.44 |
| 6 | −99.671 | 45.00 | | |
| 7 | ∞ | 5.59 | | |
| 8 | 208.874 | 3.32 | 1.80420 | 46.50 |
| 9 | −92.178 | 1.50 | | |
| 10 | 34.064 | 1.30 | 1.80518 | 25.46 |
| 11 | 19.670 | 4.35 | 1.72000 | 43.90 |
| 12 | 78.337 | 21.39 | | |
| 13 | 29.821 | 1.00 | 1.84666 | 23.78 |
| 14 | 16.405 | 4.69 | 1.48749 | 70.44 |
| 15 | −80.810 | 1.82 | | |
| 16 | −35.233 | 1.30 | 1.48749 | 70.44 |
| 17 | 22.113 | 7.90 | | |
| 18 | 46.050 | 3.80 | 1.77250 | 49.62 |
| 19 | −49.907 | 4.00 | | |
| 20 | ∞ | 22.00 | 1.58913 | 61.25 |
| 21 | ∞ | | | |

| | short focal | intermediate | long focal |
|---|---|---|---|
| | length end | focal length | length end |
| aperture ratio 1: | 2.40 | 2.49 | 2.58 |
| focal length | 19.321 | 24.182 | 28.962 |
| angle of projected | 57.1 | 46.0 | 38.4 |
| view (degree) | | | |
| variable interval | 45.000 | 25.000 | 11.895 |
| d 46 | | | |
| variable interval | 1.820 | 5.200 | 8.537 |
| d 55 | | | |
| incident angle to | 6.0 | 5.7 | 5.5 |
| element of principal ray | | | |
| (degree) (telecentric property) | | | |

| | |
|---|---|
| projector distance | 1000 |
| zooming power | 1.5 |
| fw | 19.321 |
| ft | 28.962 |
| f1 | −44.659 |
| f2 | 35.911 |
| f3 | 158.713 |
| fb | 20.317 |
| f2/f1 | −0.804 |
| fb/fw | 1.052 |
| ft/f3 | 0.183 |

In Table 7, symbol R indicates a radius of curvature, symbol d indicates a lens thickness or an air gap, symbol Nd indicates a refractive index of a d line (588 nm), and symbol Vd indicates Abbe's number of the d line. The relationship between a subscript of the symbol R and the lens and the relationship between a subscript of the symbol d and lens are set as shown in FIG. 25. Further, in Table 7, symbol f₁ indicates a focal length of the first lens group G₂₁, symbol f₂ indicates a focal length of the second lens group G₂₂, and symbol f₃ indicates a focal length of the third lens group G₂₃.

Further, in Table 7, symbol f_{w} indicates a focal length at the short focal end, symbol fₜ indicates a focal length at the long focal end, and symbol f_{b}, indicates combined back focusing from the first lens group G₂₁ to the third lens group G₂₃.

Further, a projection distance is set to 1000 mm in the third embodiment. Here, in Table 1, all unit of a numerical-value which indicates a length is mm with no designation.

With the use of the zoom lens of the numerical-value example 1, it is possible to provide a projection-use zoom lens constituted of lenses smaller in number than the conventional zoom lens, that is, 8 lenses. Here, in this explanation, with respect to a compound lens which is a constitutional element of a group, a whole compound lens is counted as one lens. Further, the zoom lens of the numerical-value example 1, as described in Table 1, keeps telecentricity.

The zoom lens according to the third embodiment can be used as a projection-use lens for a projector.

(Constitution of Numerical-Value Example 2 According to Third Embodiment)

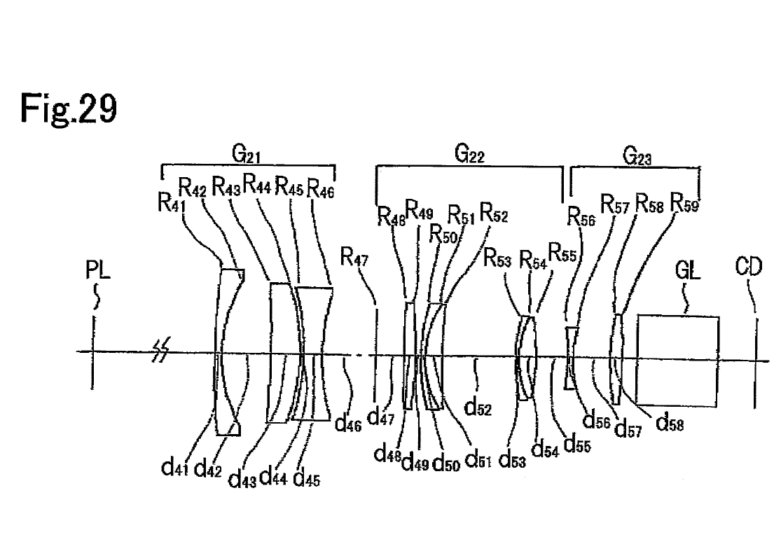

Next, FIG. 29 shows the constitution of a zoom lens according to the numerical-value example 2 of the third embodiment. Here, in the explanation of the numerical-value example 2, with respect to the constitutional elements and properties substantially equal to the constitutional elements and the properties of the numerical-value example 1, the explanation is simplified by using the same symbols.

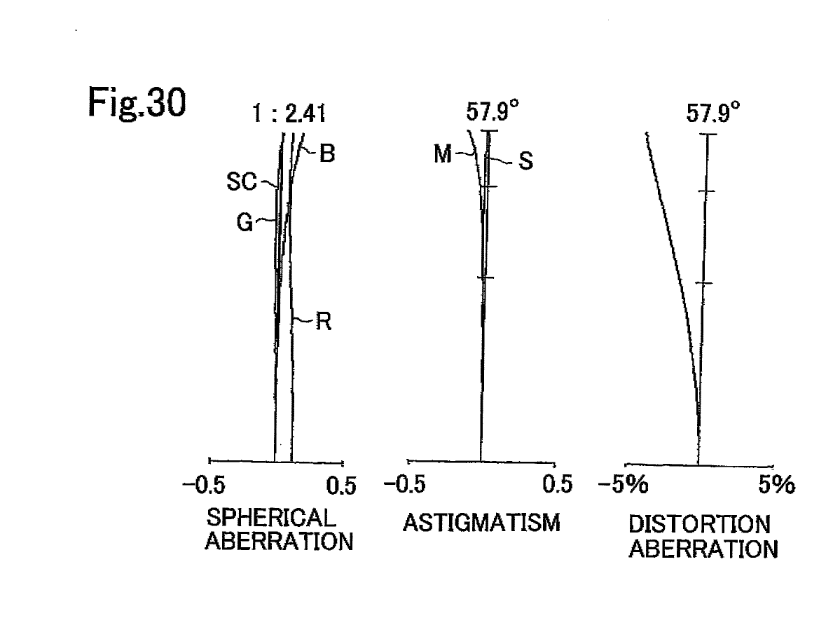

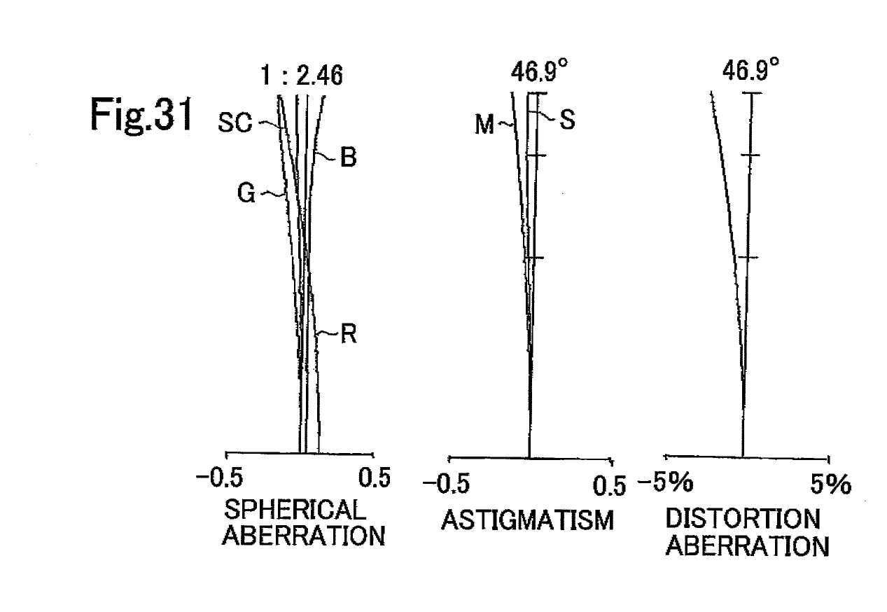

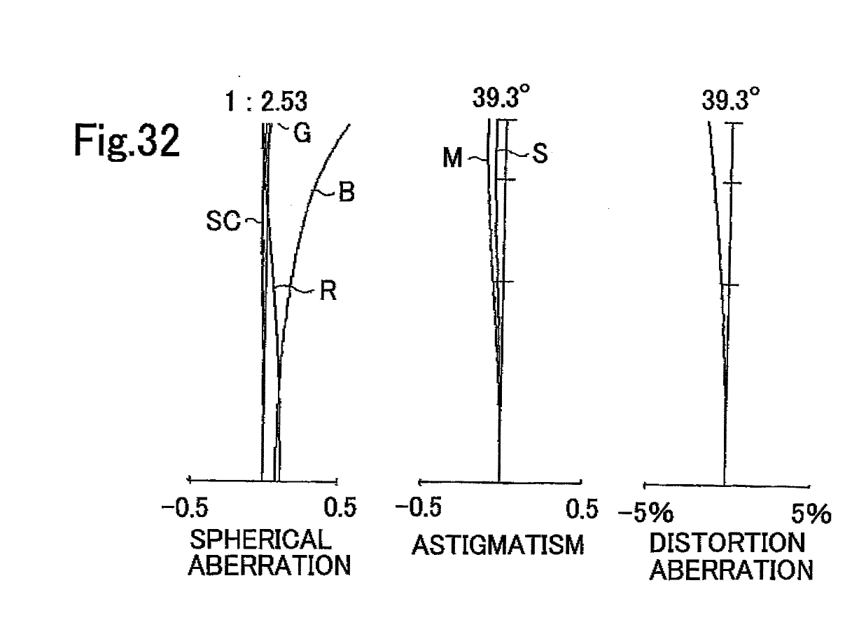

FIG. 30 to FIG. 32 show various aberrations of the numerical-value example 2. FIG. 30 shows various aberrations at a short focal end, FIG. 31 shows various aberrations at an intermediate focal position, and FIG. 32 shows various aberrations at a long focal end. Further, various properties of the numerical-value example 2 are shown in Table 8.

TABLE 8

| | R | d | Nd | Vd |
|---|---|---|---|---|
| 1 | 131.0658 | 2.00 | 1.80420 | 46.50 |
| 2 | 30.5760 | 13.01 | | |
| 3 | −182.1067 | 8.00 | 1.80518 | 25.46 |
| 4 | −41.2759 | 1.00 | | |
| 5 | −45.8909 | 5.00 | 1.48749 | 70.44 |
| 6 | 42.6480 | 40.68 | | |
| 7 | ∞ | 7.82 | | |
| 8 | 242.4800 | 3.20 | 1.80420 | 46.50 |
| 9 | −99.5525 | 1.50 | | |
| 10 | 37.9283 | 1.30 | 1.80518 | 25.46 |
| 11 | 20.2581 | 4.52 | 1.72000 | 43.90 |
| 12 | 117.9600 | 19.85 | | |
| 13 | 32.0721 | 1.00 | 1.84666 | 23.78 |
| 14 | 18.9125 | 4.55 | 1.48749 | 70.44 |
| 15 | −52.5715 | 1.24 | | |
| 16 | −42.1738 | 1.30 | 1.48749 | 70.44 |
| 17 | 21.4747 | 10.18 | | |
| 18 | 47.6799 | 3.39 | 1.77250 | 49.62 |
| 19 | −67.5253 | 4.00 | | |
| 20 | ∞ | 22.00 | 1.58913 | 61.25 |
| 21 | ∞ | | | |

| | short focal | intermediate | long focal |
|---|---|---|---|
| | length end | focal length | length end |
| aperture ratio 1: | 2.41 | 2.46 | 2.53 |
| focal length | 19.321 | 24.182 | 28.961 |
| angle of projected | 57.9 | 46.9 | 39.3 |
| view (degree) | | | |
| variable interval | 40.685 | 25.000 | 14.674 |
| d 46 | | | |
| variable interval | 1.243 | 5.073 | 8.874 |
| d 55 | | | |
| incident angle to | 6.0 | 5.7 | 5.5 |
| element of principal ray | | | |
| (degree) (telecentric property) | | | |

| | |
|---|---|
| projector distance | 1000 |
| zooming power | 1.5 |
| fw | 19.321 |
| ft | 28.961 |
| f1 | −33.885 |
| f2 | 34.118 |
| f3 | 284.580 |
| fb | 28.148 |
| f2/f1 | −1.007 |
| fb/fw | 1.482 |
| ft/f3 | 0.100 |

Other constitutions and advantages of the numerical-value example 2 are substantially equal to the constitutions and advantages of the numerical-value example 1 and hence, the more detailed explanation is omitted.

(Constitution of Numerical-Value Example 3 According to Third Embodiment)

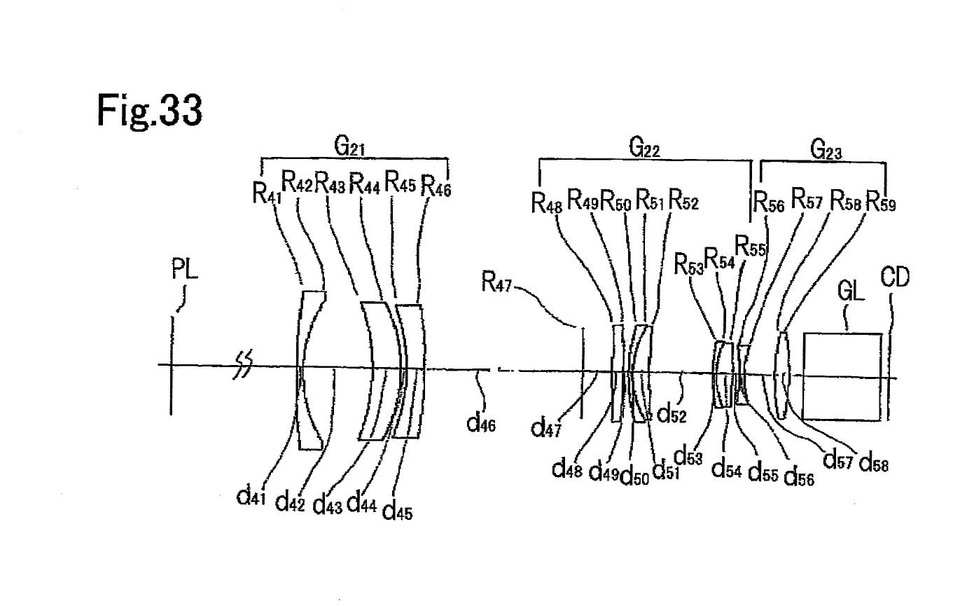

Next, FIG. 33 shows the constitution of a zoom lens according to the numerical-value example 3 of the third embodiment. Here, in the explanation of the numerical-value example 3, with respect to the constitutional elements and properties substantially equal to the constitutional elements and the properties of the numerical-value example 1, the explanation is simplified by using the same symbols.

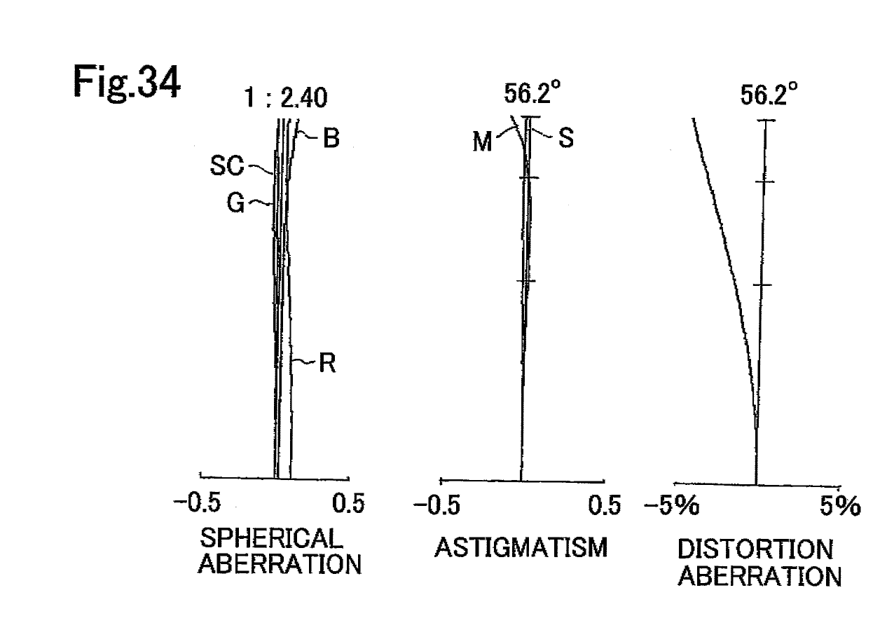

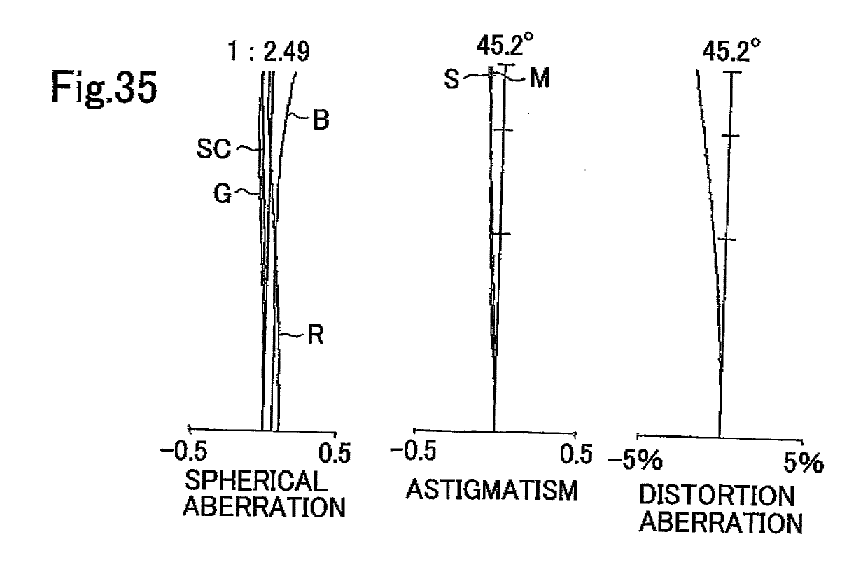

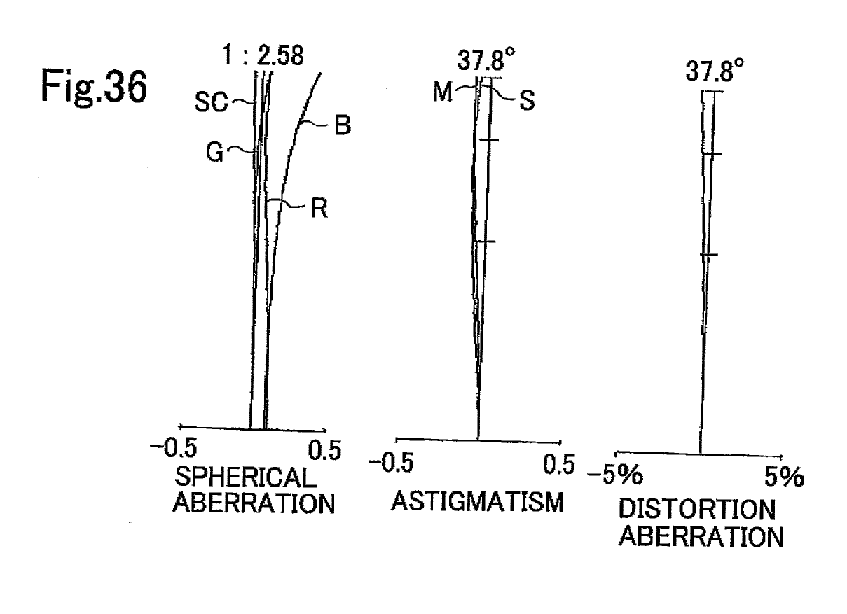

FIG. 34 to FIG. 36 show various aberrations of the numerical-value example 3. FIG. 34 shows various aberrations at a short focal end, FIG. 35 shows various aberrations at an intermediate focal position, and FIG. 36 shows various aberrations at a long focal end. Further, various properties of the numerical-value example 3 are shown in Table 9.

TABLE 9

| | R | d | Nd | Vd |
|---|---|---|---|---|
| 1 | 111.5490 | 2.00 | 1.80420 | 46.50 |
| 2 | 28.5662 | 19.61 | | |
| 3 | −42.9438 | 8.00 | 1.80518 | 25.46 |
| 4 | −32.8929 | 1.66 | | |
| 5 | −37.8780 | 5.00 | 1.48749 | 70.44 |
| 6 | −88.6820 | 45.00 | | |
| 7 | ∞ | 8.39 | | |
| 8 | 214.7366 | 3.11 | 1.80420 | 46.50 |
| 9 | −117.6225 | 1.50 | | |
| 10 | 32.2729 | 1.30 | 1.80518 | 25.46 |
| 11 | 18.4092 | 4.99 | 1.72000 | 43.90 |
| 12 | 110.8199 | 18.25 | | |
| 13 | 33.7817 | 1.00 | 1.84666 | 23.78 |
| 14 | 16.3758 | 4.51 | 1.48749 | 70.44 |
| 15 | −127.7361 | 1.92 | | |
| 16 | −38.6645 | 1.30 | 1.48749 | 70.44 |
| 17 | 19.6610 | 8.38 | | |
| 18 | 40.7623 | 3.95 | 1.77250 | 49.62 |
| 19 | −51.5099 | 4.00 | | |
| 20 | ∞ | 22.00 | 1.58913 | 61.25 |
| 21 | ∞ | | | |

| | short focal | intermediate | long focal |
|---|---|---|---|
| | length end | focal length | length end |
| aperture ratio 1: | 2.40 | 2.49 | 2.58 |
| focal length | 18.997 | 23.759 | 28.458 |
| angle of projected | 56.2 | 45.2 | 37.8 |
| view (degree) | | | |
| variable interval | 45.000 | 22.312 | 7.311 |
| d 46 | | | |
| variable interval | 1.924 | 4.843 | 7.748 |
| d 55 | | | |
| incident angle to | 6.0 | 5.8 | 5.7 |
| element of principal ray | | | |
| (degree) (telecentric property) | | | |

| | |
|---|---|
| projector distance | 1000 |
| zooming power | 1.5 |
| fw | 18.997 |
| ft | 28.458 |
| f1 | −52.532 |
| f2 | 35.984 |
| f3 | 126.269 |
| fb | 20.038 |
| f2/f1 | −0.685 |
| fb/fw | 1.015 |
| ft/f3 | 0.233 |

other constitutions and advantages of the numerical-value example 3 are substantially equal to the constitutions and advantages of the numerical-value example 1 and hence, the more detailed explanation is omitted.

Here, the present invention is not limited to the above-mentioned embodiments and, for example, various modifications can be made without departing from the gist of the present invention.

What is claimed is:

1. A zoom lens capable of varying power between a short focal end and a long focal end thereof, the zoom lens comprising a first lens group, a second lens group, a third lens group and a fourth lens group arranged sequentially from a projection plane side, wherein
the first lens group is constituted of three lenses consisting of one negative lens, one positive lens and one negative lens arranged sequentially from the projection plane side and has a negative power,
the second lens group is constituted of three lenses in total consisting of one compound lens ox one positive lens, one positive lens or one compound lens, and one compound lens arranged sequentially from the projection plane side and has a positive power,
the third lens group is constituted of one negative lens, and
the fourth lens group is constituted of one positive lens, and
in varying power, the zoom lens is configured such that the first lens group and the second lens group are moved, while the third lens group and the fourth lens group are fixed and, further, the zoom lens is configured to move the third lens group for focusing.

2. A zoom lens according to claim 1, wherein the zoom lens is configured to satisfy a following conditional expression (1).
0.7≦|f₂/f₁|≦1.5 (1)
f₁: combined focal length of the first lens group
f₂: combined focal length of the second lens group

3. A zoom lens according to claim 1, wherein the zoom lens is configured to satisfy a following conditional expression (2).
1.5≦|f_{b}/f_{w}|≦2.5 (2)
f_{b}: combined back focusing ranging from the first lens group to the third lens group
f_{w}: focal length at the short focal end

4. A zoom lens claim 1, wherein the zoom lens is configured to satisfy a following conditional expression (3).
0.08≦|f_{T}/f₃|≦0.3 (3)
f₃: combined focal length of the third lens group
f_{T}: focal length at the long focal end

5. A zoom lens capable of varying power between a short focal end and a long focal end thereof, the zoom lens comprising a first lens group, a second lens group and a third lens group arranged sequentially from a projection plane side, wherein
the first lens group is constituted of three lenses consisting of one negative lens, one positive lens and one negative lens arranged sequentially from the projection plane side and has a negative power,
the second lens group is constituted of three lenses in total consisting of one positive lens, one compound lens constituted of two lenses, and one compound lens constituted of two lenses arranged sequentially from the projection plane side and has a positive power, and
the third lens group is constituted of two lenses consisting of one negative lens and one positive lens arranged sequentially from the projection plane side and has a positive power, and
in varying power, the zoom lens is configured such that the first lens group and the second lens group are moved, while the third lens group is fixed and, further, the zoom lens is configured to move the third lens group for focusing.

6. A zoom lens according to claim 5, wherein the zoom lens is configured to satisfy a following conditional expression (1).
0.6≦|f₂/f₁|≦1.3 (1)
f₁: combined focal length of the first lens group
f₂: combined focal length of the second lens group

7. A zoom lens according to claim 5, wherein the zoom lens is configured to satisfy a following conditional expression (2).
0.8≦|f_{b}/f_{w}|≦1.8 (2)
f_{b}: combined back focusing ranging from the first lens group to the third lens group
f_{w}: focal length at the short focal end

8. A zoom lens according to claim 5, wherein the zoom lens is configured to satisfy a following conditional expression (3).
0.08≦|fₜ/f₃|≦0.3 (3)
fₜ: focal length at the long focal end
f₃: combined focal length of the third lens group

9. A projector including a zoom lens described in any one of claims 1 to 8.
